(19) United States
(12) Patent Application Publication
(10) Pub. No.: US 2021/0272045 A1
(43) Pub. Date: Sep. 2, 2021

(54) AUTOMATICALLY SELECTING SUB-CONTRACTORS AND ESTIMATING COST FOR CONTRACTED TASKS

(71) Applicant: WeKnow Ltd., Kibbutz Yakum (IL)

(72) Inventors: Itai RESHEF, Kibbutz Yakum (IL); Bnaya ESHET, Givatayim (IL); Nadav OFIR, Hod-HaSharon (IL)

(73) Assignee: WeKnow Ltd., Kibbutz Yakum (IL)

(21) Appl. No.: 17/187,951

(22) Filed: Mar. 1, 2021

Related U.S. Application Data
(60) Provisional application No. 62/983,676, filed on Mar. 1, 2020.

(51) Int. Cl. G06Q 10/06; G06N 20/00; G06N 7/00

(52) U.S. Cl. CPC G06Q 10/063112; G06N 7/005; G06N 20/00; G06Q 10/06398

(57) ABSTRACT

Provided herein are methods and systems for automatically selecting expert sub-contractors for executing tasks, comprising extracting requirements of a contracted task form a task description, applying an evolving selection algorithm to compute a success score and an enhancement score for each of at least some expert sub-contractors evaluated for executing the contracted task, selecting a subset of expert sub-contractors based on their success and enhancement scores such that the subset includes one or more expert sub-contractors having success scores exceeding a first threshold and one or more expert sub-contractors having enhancement scores exceeding a second threshold, and instructing each expert sub-contractor of the subset to execute the contracted task. Wherein the success score indicates an estimated probability of the respective expert sub-contractor to successfully execute the contracted task and the enhancement score indicates an estimated enhancement of the evolving selection algorithm by the respective expert sub-contractor executing the contracted task.

### RELATED APPLICATION(S)

This application claims the benefit of priority under 35 USC § 119(e) of U.S. Provisional Patent Application No. 62/983,676 filed on Mar. 1, 2020, the contents of which are incorporated by reference as if fully set forth herein in their entirety.

### FIELD AND BACKGROUND OF THE INVENTION

The present invention, in some embodiments thereof, relates to selecting expert sub-contractors and estimating cost for executing contracted (outsourced) tasks and, more specifically, but not exclusively, to automatically selecting expert sub-contractors and estimating cost for executing contracted tasks using Machine Learning (ML) models evolving to scale according to dynamic availability of the expert sub-contractors.

Analyses, researches, studies and/or the like such as, for example, market analyses may often require specific knowledge, expertise, experience and/or tools which are not readily available to many of the organizations, companies, institutes and/or the like who wish to conduct such market analyses.

This limitation has significantly accelerated the trend of contracting and outsourcing such analyses, researches, studies (tasks) to experts, for example, analysts, professionals and/or the like having the knowledge, expertise, experience and/or tools for executing (conducting) the contracted tasks.

As such, large pools of experts have developed where the experts may sub-contract their services in one or more contractual forms, for example, per contracted task, per a number of contracted tasks, on retainer and/or the like.

### SUMMARY OF THE INVENTION

According to a first aspect of the present invention there is provided a computer implemented method of selecting automatically expert sub-contractors most relevant for executing tasks, comprising:
Analyzing a task description defined for a contracted task to extract a plurality of requirements of the contracted task.
Applying an evolving selection algorithm to compute at least a success score and an enhancement score for each of at least some of a plurality of expert sub-contractors evaluated for executing the contracted task. The success score indicating an estimated probability of the respective expert sub-contractor to successfully execute the contracted task according to the plurality of requirements and the enhancement score indicating an estimated enhancement of the evolving selection algorithm by execution of the contracted task by the respective expert sub-contractor.
Selecting automatically a subset from the at least some expert sub-contractors based on the computed success and enhancement scores according to one or more selection rules such that the subset comprising one or more expert sub-contractors having a success score exceeding a first threshold and one or more other expert sub-contractors having an enhancement score exceeding a second threshold.
Instructing each expert sub-contractor of the subset to execute the contracted task.

According to a second aspect of the present invention there is provided a system for selecting automatically expert sub-contractors most relevant for executing tasks, comprising one or more processors configured for executing a code. The code comprising:
Code instructions to analyze a task description defined for a contracted task to extract a plurality of requirements of the contracted task.
Code instructions to apply an evolving selection algorithm to compute at least a success score and an enhancement score for each of at least some of a plurality of expert sub-contractors evaluated for executing the contracted task. The success score indicating an estimated probability of the respective expert sub-contractor to successfully execute the contracted task according to the plurality of requirements and the enhancement score indicating an estimated enhancement of the evolving selection algorithm by execution of the contracted task by the respective expert sub-contractor.
Code instructions to select automatically a subset from the at least some expert sub-contractors based on the computed success and enhancement scores according to one or more selection rules such that the subset comprising one or more expert sub-contractors having a success score exceeding a first threshold and one or more other expert sub-contractors having an enhancement score exceeding a second threshold.
Code instructions to instruct each expert sub-contractor of the subset to execute the contracted task.

According to a third aspect of the present invention there is provided a computer implemented method of estimating automatically cost of tasks contracted to expert sub-contractors, comprising:
Extracting a plurality of requirements from a task description defined for a contracted task.
Estimating a scope of work of the contracted task based on analysis of the plurality of requirements.
Estimating, based on the estimated scope of work, a cost of the contracted task, the cost is an aggregation of a plurality of cost portions each estimated for reward for execution of the contracted task by a respective one of a subset of expert sub-contractors selected from a plurality of expert sub-contractors.
Initiating a transmission of an offer to each of the sub-contractors of the subset to execute the contracted task in return to a respective one of the plurality of cost portions estimated for the respective expert sub-contractor.

According to a fourth aspect of the present invention there is provided a system for estimating automatically cost of tasks contracted to expert sub-contractors, comprising one or more processors configured for executing a code. The code comprising:
Code instructions to extract a plurality of requirements from a task description defined for a contracted task.
Code instructions to estimate a scope of work of the contracted task based on analysis of the plurality of requirements.
Code instructions to estimate, based on the estimated scope of work, a cost of the contracted task, the cost is an aggregation of a plurality of cost portions each estimated for reward for execution of the contracted task by a respective one of a subset of expert sub-contractors selected from a plurality of expert sub-contractors.
Code instructions to initiate a transmission of an offer to each of the sub-contractors of the subset to execute the contracted task in return to a respective one of the plurality of cost portions estimated for the respective expert sub-contractor.

According to a fifth aspect of the present invention there is provided a computer implemented method of computing automatically commitment fees required from expert sub-contractors to ensure their commitment to execute contracted tasks, comprising:
Receiving a value of a cost allocated to reward a subset of expert sub-contractors selected from a plurality of expert sub-contractors for executing a contracted task.
Computing a commitment fee for each of the expert sub-contractors of the subset based on the cost value.
Extracting one or more expert attributes of each of the expert sub-contractors of the subset, the expert attributes comprising one or more members of a group consisting of: a ranking score of the respective expert sub-contractor with respect to one or more another expert sub-contractor, and/or one or more professional attributes of the respective expert sub-contractor.
Computing an adjusted commitment fee of one or more of the expert sub-contractors of the subset according to the one or more of the expert attributes of the respective expert sub-contractor.
Initiating a transmission of a request to each of the expert sub-contractors of the subset to pay the commitment fee computed for the respective expert sub-contractor in order to be potentially selected for executing the contracted task.

According to a sixth aspect of the present invention there is provided a system for computing automatically commitment fees required from expert sub-contractors to ensure their commitment to execute contracted tasks, comprising one or more processors configured for executing a code. The code comprising:
Code instructions to receive a value of a cost allocated to reward a subset of expert sub-contractors selected from a plurality of expert sub-contractors for executing a contracted task.
Code instructions to compute a commitment fee for each of the expert sub-contractors of the subset based on the cost value.
Code instructions to extract one or more expert attributes of each of the expert sub-contractors of the subset, the expert attributes comprising one or more members of a group consisting of: a ranking score of the respective expert sub-contractor with respect to one or more another expert sub-contractor, and/or one or more professional attributes of the respective expert sub-contractor.
Code instructions to compute an adjusted commitment fee of one or more of the expert sub-contractors of the subset according to the one or more of the expert attributes of the respective expert sub-contractor.
Code instructions to initiate a transmission of a request to each of the expert sub-contractors of the subset to pay the commitment fee computed for the respective expert sub-contractor in order to be potentially selected for executing the contracted task.

According to a seventh aspect of the present invention there is provided a computer implemented method of computing automatically a distribution of cost allocated for reward to a plurality of expert sub-contractors who each independently executed a contracted task, comprising:
Receiving a plurality of post-execution reviews each created for a respective one of a plurality of expert sub-contractors of a selected subset who each independently executed a contracted task. Each of the plurality of post-execution reviews comprising one or more compliance parameters of a respective outcome of the contracted task executed by the respective expert sub-contractor.
Computing a satisfaction score for each of the plurality of expert sub-contractors by analyzing one or more of the compliance parameters extracted from a respective one of the plurality of post-execution reviews.
Computing a split of a cost of the contracted task to the plurality of expert sub-contractors based on a proportion between the satisfaction scores computed for the plurality of expert sub-contractors.
Initiating distribution of the cost to the plurality of expert sub-contractors according to the computed split.

According to an eighth aspect of the present invention there is provided a system for computing automatically a distribution of cost of a contracted task to a plurality of expert sub-contractors who each independently executed the contracted task, comprising one or more processors configured for executing a code. The code comprising:
Code instructions to receive a plurality of post-execution reviews each created for a respective one of a plurality of expert sub-contractors of a selected subset who each independently executed a contracted task. Each of the plurality of post-execution reviews comprising one or more compliance parameters of a respective outcome of the contracted task executed by the respective expert sub-contractor.
Code instructions to compute a satisfaction score for each of the plurality of expert sub-contractors by analyzing one or more of the compliance parameters extracted from a respective one of the plurality of post-execution reviews.
Code instructions to compute a split of a cost of the contracted task to the plurality of expert sub-contractors based on a proportion between the satisfaction scores computed for the plurality of expert sub-contractors.
Code instructions to initiate distribution of the cost to the plurality of expert sub-contractors according to the computed split.

According to a ninth aspect of the present invention there is provided a computer implemented method of automatically selecting expert sub-contractors for executing tasks, computing commitment fees for the selected expert sub-contractors and splitting a cost allocated to reward the selected expert sub-contractors, comprising:
Analyzing a task description defined for a contracted task to extract a plurality of requirements of the contracted task.
Selecting a subset of expert sub-contractors from a plurality of expert sub-contractors according to a success score and an enhancement score computed by an evolving selection algorithm for each of at least some of the plurality of expert sub-contractors. Wherein the success score indicates an estimated probability of the respective expert sub-contractor to successfully execute the contracted task according to the plurality of requirements, and wherein the enhancement score indicates an estimated enhancement of the evolving selection algorithm as result of execution of the contracted task by the respective expert sub-contractor.
Estimating a cost of the contracted task based on the plurality of requirements, the cost aggregates a plurality of cost portions each estimated for reward for execution of the contracted task by a respective one of the subset of expert sub-contractors.
Computing a commitment fee for each of the expert sub-contractors of the subset based on the estimate cost, the commitment fee is adjusted for one or more of the expert sub-contractors of the subset according to one or more expert attributes.
Receiving an agreement indication from at least some agreeing expert sub-contractors of the subset who agree to pay their respective commitment fee.
Instructing at least some of the agreeing expert sub-contractors to execute the contracted task.
Computing an adjusted split of the estimated cost to reward the expert sub-contractors who executed the contracted task, the adjusted split is computed based on the plurality of cost portions and adjusted according to a proportion between satisfaction scores computed for the expert sub-contractors who executed the contracted task according to post execution reviews created by a contractor of the contracted task.

In a further implementation form of the first, second, third, fourth, fifth, sixth, seventh, eighth and/or ninth aspects, the plurality of requirements comprising at least some of: a knowledge domain of the contracted task, a field of the contracted task, a title of the contracted task, a market segment targeted by the contracted task, a scope of work of the contracted task, a geographical area targeted by the contracted task, a timing requirement of the contracted task, and/or one or more preferred expert sub-contractors identified by a contractor of the contracted task.

In a further implementation form of the first, second, third, fourth, fifth, sixth, seventh, eighth and/or ninth aspects, the evolving selection algorithm is configured to compute the success score of each of the at least some expert sub-contractors according to one or more expert attributes of the respective expert sub-contractor. The expert attributes of each expert sub-contractor comprise one or more members of a group consisting of: a ranking score of the respective expert sub-contractor and/or one or more professional attributes of the respective expert sub-contractor.

In a further implementation form of the first, second, third, fourth, fifth, sixth, seventh, eighth and/or ninth aspects, the ranking score is computed for the respective expert sub-contractor based on a compliance score computed for an outcome of one or more previous contracted tasks executed by the respective expert sub-contractor. The compliance score is computed based on one or more outcome parameters of the outcome. The outcome parameters comprise one or more members of a group consisting of: quality of the outcome, compliance of the outcome with one or more timing requirements of the plurality of requirement, and/or responsiveness of the respective expert sub-contractor during the execution of the contracted task.

In a further implementation form of the first, second, third, fourth, fifth, sixth, seventh, eighth and/or ninth aspects, one or more outcome parameters are extracted from one or more of: a feedback received from a contractor of the respective contracted task for the outcome received from the respective expert sub-contractor, a professional review conducted for the outcome received from the respective expert sub-contractor, and/or an automatic analysis of the outcome received from the respective expert sub-contractor.

In a further implementation form of the first, second, third, fourth, fifth, sixth, seventh, eighth and/or ninth aspects, the compliance score computed for each of the expert sub-contractors of the subset based on the outcome of the contracted task executed by the respective expert sub-contractor is used by the evolving selection algorithm to adjust the ranking score of the respective expert sub-contractor.

In a further implementation form of the first, second, third, fourth, fifth, sixth, seventh, eighth and/or ninth aspects, the evolving selection algorithm is further configured to adjust the ranking score of one or more expert sub-contractors of the subset with respect to the ranking score of one or more other expert sub-contractors of the plurality of expert sub-contractors according to one or more ranking parameters. The ranking parameters comprise one or more members of a group consisting of: a number of previous contracted tasks executed by one or more of the plurality of expert sub-contractors in a knowledge domain of the contracted task, an aggregated compliance score computed for one or more of the plurality of expert sub-contractors based on his execution of a plurality of previous contracted tasks in a knowledge domain of the contracted task, and/or a number of expert sub-contractors available in the knowledge domain of the contracted task.

In a further implementation form of the first, second, third, fourth, fifth, sixth, seventh, eighth and/or ninth aspects, the professional attributes comprise one or more members of a group consisting of: age, gender, a knowledge domain, experience, language, geographical location, expected reward for executing the contracted task, availability, and an influence evaluated for the respective expert sub-contractor on at least another one of the plurality of expert sub-contractors.

In an optional implementation form of the first, second, third, fourth, fifth, sixth, seventh, eighth and/or ninth aspects, one or more professional attributes of the respective expert sub-contractor are extracted from one or more online resources which comprise one or more of: a private online resource and/or a public online resource.

In a further implementation form of the first, second, third, fourth, fifth, sixth, seventh, eighth and/or ninth aspects, the evolving selection algorithm is further configured to adjust the success score computed for the respective expert sub-contractor according to a respective weight assigned to each of a plurality of professional attributes of the respective expert sub-contractor.

In a further implementation form of the first, second, third, fourth, fifth, sixth, seventh, eighth and/or ninth aspects, the evolving selection algorithm is configured to compute the enhancement score for each of the at least some expert sub-contractors based on one or more past engagement parameters identified for the respective expert sub-contractor. The past engagement parameters comprise one or more members of a group consisting of: a number of offers submitted to the respective expert sub-contractor for executing previous contracted tasks, a number of offers accepted by the respective expert sub-contractor for executing previous contracted tasks, a number of previous contracted tasks submitted to the respective expert sub-contractor for execution, a reward range of previous contracted tasks accepted or declined by the respective expert sub-contractor, a trend of the reward range accepted or declined by the respective expert sub-contractor, and/or a knowledge domain of previous contracted tasks accepted or declined by the respective expert sub-contractor.

In an optional implementation form of the first, second, third, fourth, fifth, sixth, seventh, eighth and/or ninth aspects, the evolving selection algorithm is further configured to compute the enhancement score for one or more of the plurality of expert sub-contractors based on estimated source cause of one or more of the past engagement parameters identified for the respective expert sub-contractor. The estimated source cause is a member of a group consisting of: type of the knowledge domain of one or more of the previous contracted tasks, a value of the reward offered for executing one or more of the previous contracted tasks, availability or unavailability due to personal reasons, availability or unavailability due to cultural reasons, and/or confidence of the one or more expert sub-contractors in the selection process.

In an optional implementation form of the first, second, third, fourth, fifth, sixth, seventh, eighth and/or ninth aspects, the evolving selection algorithm is further configured to compute the enhancement score for one or more of the plurality of expert sub-contractors based on an estimated future demand for executing a plurality of future contracted tasks, the future demand is estimated based on a one or more of: a knowledge domain trend identified for previous contracted tasks, a reward range trend identified for previous contracted tasks, geographical areas targeted by previous contracted tasks, and/or market segments targeted by previous contracted tasks.

In an optional implementation form of the first, second, third, fourth, fifth, sixth, seventh, eighth and/or ninth aspects, the future demand is estimated manually by one or more experts.

In a further implementation form of the first, second, third, fourth, fifth, sixth, seventh, eighth and/or ninth aspects, the evolving selection algorithm is utilized by one or more trained machine learning models trained with a plurality of training tasks evaluated for execution by the plurality of expert sub-contractors coupled with respective outcomes of execution of each of the plurality of training tasks by one or more of the plurality of expert sub-contractors.

In an optional implementation form of the first, second, third, fourth, fifth, sixth, seventh, eighth and/or ninth aspects, the evolving selection algorithm is further configured to select to the subset one or more unlisted expert sub-contractors identified in one or more online resource. The selection is based on a match between one or more professional attributes identified for each of the one or more unlisted expert sub-contractors and at least some of the plurality of requirements.

In an optional implementation form of the first, second, third, fourth, fifth, sixth, seventh, eighth and/or ninth aspects, the evolving selection algorithm is further configured to select to the subset one or more unlisted expert sub-contractors recommended by one or more of the plurality expert sub-contractors.

In an optional implementation form of the first, second, third, fourth, fifth, sixth, seventh, eighth and/or ninth aspects, the evolving selection algorithm is further configured to select to the subset one or more expert sub-contractors from one or more other knowledge domains different from the knowledge domain of the contracted task. The selection is based on at least partial match between one or more professional attributes identified for one or more of the expert sub-contractors and the plurality of requirements.

In a further implementation form of the first, second, third, fourth, fifth, sixth, seventh, eighth and/or ninth aspects, the first threshold is defined to ensure a minimal success probability of one or more of the expert sub-contractors of the subset to successfully execute the contracted task by complying with the plurality of requirements.

In a further implementation form of the first, second, third, fourth, fifth, sixth, seventh, eighth and/or ninth aspects, the second threshold is defined to ensure a minimal probability of the evolving selection algorithm to enhance based on an outcome of the execution of the contracted task by one or more of the expert sub-contractors of the subset.

The enhancement comprises one or more of: computing an initial success score and/or an initial enhancement score for one or more new expert sub-contractors, adjusting the success score and/or the enhancement score of one or more of the plurality of expert sub-contractors, and/or enhancing one or more grouping algorithms used by the evolving selection algorithm to select at least some expert sub-contractors as candidates for executing one or more future contracted tasks.

In a further implementation form of the first, second, third, fourth, fifth, sixth, seventh, eighth and/or ninth aspects, one or more of the selection rules are defined to balance between the first and second thresholds in order to achieve maximum enhancement of the evolving selection algorithm while ensuring a successful execution of the contracted task.

In a further implementation form of the first, second, third, fourth, fifth, sixth, seventh, eighth and/or ninth aspects, the task description is fabricated by a contractor of the task.

In an optional implementation form of the first, second, third, fourth, fifth, sixth, seventh, eighth and/or ninth aspects, a User Interface (UI) of a client device used by the contractor to fabricate the task description is adjusted to follow an online guided interactive process comprising presenting to the contractor a plurality of guiding questions and receiving from the contractor information in response to the plurality of guiding questions.

In an optional implementation form of the first, second, third, fourth, fifth, sixth, seventh, eighth and/or ninth aspects, one or more of the plurality of guiding questions are dynamically adjusted according to information provided by the contractor in response to one or more previously presented guiding questions.

In an optional implementation form of the first, second, third, fourth, fifth, sixth, seventh, eighth and/or ninth aspects, the task description is enhanced automatically based on a plurality of template task descriptions.

In an optional implementation form of the first, second and/or ninth aspects, one or more recommendations are recommended to contractor for the contracted task based on analysis of the task description, the one or more recommendation is selected based on one or more of: one or more predefined recommendation rules, and/or a dynamic recommendation model created based on a plurality of previously contracted tasks executed by at least some of the plurality expert sub-contractors.

In an optional implementation form of the third, fourth and/or ninth aspects, one or more expert sub-contractors of the subset are selected based on agreement of the respective expert sub-contractor to commit to executing the contracted task by paying a commitment fee.

In a further implementation form of the first, second, third, fourth, fifth, sixth, seventh, eighth and/or ninth aspects, each of the cost portions is estimated based on an estimated number of hours required for the respective expert sub-contractor to execute the contracted task, the estimated number of required hours is estimated based on the estimated scope of work.

In a further implementation form of the third, fourth and/or ninth aspects, each of the cost portions is computed by one or more ML models configured to estimate the cost of the contracted task based on one or more pricing paradigms learned based on analysis of a plurality of previously contracted and executed tasks.

In a further implementation form of the third, fourth and/or ninth aspects, the plurality of cost portions are estimated for the reward to each respective expert sub-contractor of a subset based on a differential compensation to each of the expert sub-contractors. The differential compensation is computed based on one or more expert attributes of the respective expert sub-contractor. The expert attributes comprise one or more members of a group consisting of: a ranking score of the respective expert sub-contractor with respect to one or more another expert sub-contractor, and/or one or more professional attributes of the respective expert sub-contractor.

In an optional implementation form of the third, fourth and/or ninth aspects, the estimated cost is adjusted according to availability of expert sub-contractors in a knowledge domain of the contracted task among the plurality of expert sub-contractors.

In a further implementation form of the first, second, third, fourth and/or ninth aspects, the availability is determined according to one or more of: a number of expert sub-contractors in a knowledge domain of the contracted task, an expected reward of one or more of the expert sub-contractors of the subset selected for executing the contracted task, a geographical area targeted by the contracted task, and/or a scheduling attribute affecting one or more of the expert sub-contractors of the subset with respect to one or more timing requirement of the plurality of requirements.

In an optional implementation form of the third, fourth and/or ninth aspects, the estimated cost is adjusted according to availability of unlisted expert sub-contractors in the knowledge domain of the contracted task which are not listed among the plurality of expert sub-contractors.

In an optional implementation form of the third, fourth and/or ninth aspects, the estimated cost is adjusted according to a cost of one or more previous contracted tasks having at least partially similar scope of work as the contracted task.

In an optional implementation form of the third, fourth and/or ninth aspects, the estimated cost is adjusted according to a responsiveness of the expert sub-contractors of the subset to execute the contracted task in return for a respective portion of the estimated total cost, the responsiveness is determined based on a number of the expert sub-contractors of the subset who committed to execute the contracted task by paying a commitment fee.

In an optional implementation form of the third, fourth and/or ninth aspects, the estimated cost is adjusted according to past responsiveness of one or more of the expert sub-contractors of the subset to execute one or more previous contracted tasks in return for a certain reward.

In an optional implementation form of the third, fourth and/or ninth aspects, the estimated cost is adjusted according to one or more expert attributes of one or more of the expert sub-contractors of the subset.

In an optional implementation form of the first, second, third, fourth, fifth, sixth, seventh, eighth and/or ninth aspects, the commitment fee is adjusted according to a success score computed for one or more of the expert sub-contractors. The success score indicating an estimated probability of the respective expert sub-contractor to successfully execute the contracted task according to a plurality of requirements extracted from a task description of the contracted task.

In an optional implementation form of the first, second, third, fourth, fifth, sixth, seventh, eighth and/or ninth aspects, the success score computed for one or more of the expert sub-contractors is adjusted according to a respective weight assigned to each of a plurality of professional attributes of the respective expert sub-contractor.

In an optional implementation form of the first, second, third, fourth, fifth, sixth, seventh, eighth and/or ninth aspects, the commitment fee is adjusted according to an enhancement score computed for one or more of the expert sub-contractors. The enhancement score indicating an estimated enhancement achieved by execution of the contracted task by the respective expert sub-contractor to the evolving selection algorithm applied to select the subset of expert sub-contractors to execute the contracted task.

In a further implementation form of the first, second, third, fourth, fifth, sixth, seventh, eighth and/or ninth aspects, the adjusted commitment fee is computed for one or more of the expert sub-contractors according to a recruitment channel used to recruit the respective expert sub-contractor. The recruitment channel is a member of a group consisting of: a recommendation received from one or more of the plurality expert sub-contractors, a recommendation received from one or more contractor of one or more contracted task, tracking members of groups of expert sub-contractors of the plurality expert sub-contractors, a recruitment publication, and/or a recruitment automated service.

In an optional implementation form of the first, second, third, fourth, fifth, sixth, seventh, eighth and/or ninth aspects, the commitment fee is adjusted for one or more of the expert sub-contractors according to one or more coupons presented by the respective expert sub-contractor. One or more of the coupons are issued automatically to one or more of the plurality of expert sub-contractors for distribution to one or more other expert sub-contractors of the plurality expert sub-contractors.

In a further implementation form of the first, second, third, fourth, fifth, sixth, seventh, eighth and/or ninth aspects, the plurality of post-execution reviews are created by a contractor of the contracted task after completion of execution of the contracted task by the plurality of expert sub-contractors based on outcomes received from the plurality of expert sub-contractors.

In an optional implementation form of the seventh, eighth and/or ninth aspects, the split is adjusted according to a match between a success score estimated for each of the plurality of expert sub-contractors before execution of the contracted task and an actual success level of the respective expert sub-contractor evaluated for the respective expert sub-contractor after completion of the execution of the contracted task.

In an optional implementation form of the seventh, eighth and/or ninth aspects, the split is adjusted according to at least previous contracted task executed by one or more of the plurality expert sub-contractors.

In an optional implementation form of the seventh, eighth and/or ninth aspects, the split is adjusted according to one or more expert attributes of one or more of the plurality of expert sub-contractors.

In an optional implementation form of the seventh, eighth and/or ninth aspects, the split is adjusted according to a non-linear distribution function applied to reduce a degree of the proportion thus reducing differentiation between a cost portion distributed to each of the plurality of expert sub-contractors.

In an optional implementation form of the seventh, eighth and/or ninth aspects, the split is adjusted according to an evaluation conducted by least one professional.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for automatically managing tasks contracted by contractors to a plurality of expert sub-contractors, according to some embodiments of the present invention;

FIG. 2 is a flowchart of an exemplary process of automatically creating a task description for a task contracted by a contractor to a plurality of expert sub-contractors, according to some embodiments of the present invention;

FIG. 3 is a flowchart of an exemplary process of automatically selecting a subset from a plurality of expert sub-contractors to execute a task contracted by a contractor, according to some embodiments of the present invention;

FIG. 4 is a flowchart of an exemplary process of automatically estimating a cost of a task contracted by a contractor to a subset selected from a plurality of expert sub-contractors to execute the task, according to some embodiments of the present invention;

FIG. 5 is a flowchart of an exemplary process of automatically computing a commitment fee for each of a plurality of expert sub-contractors of a subset selected from a plurality of expert sub-contractors to execute a contracted task, according to some embodiments of the present invention; and

FIG. 6 is a flowchart of an exemplary process of automatically distributing cost allocated for reward to a plurality of expert sub-contractors who each independently executed a contracted task, according to some embodiments of the present invention.

### DESCRIPTION OF SPECIFIC EMBODIMENTS OF THE INVENTION

The present invention, in some embodiments thereof, relates to selecting expert sub-contractors and estimating cost for executing contracted (outsourced) tasks and, more specifically, but not exclusively, to automatically selecting expert sub-contractors and estimating cost for executing contracted tasks using Machine Learning (ML) models evolving to scale according to dynamic availability of the expert sub-contractors.

According to some embodiments of the present invention, there are provided methods, systems and computer program products for a tasks management service configured to automatically select expert sub-contractors, for example, analysts, professionals and/or the like having the knowledge, expertise, experience, capabilities and optionally tools for executing (conducting) tasks, for example, analyses, researches, studies and/or the like contracted (outsourced) by a plurality of contractors, for example, organizations, companies, institutes and/or the like.

The contracted tasks may include, for example, market analyses requested by the contractors for exploring Strengths, Weaknesses, Opportunities and Threats (SWOT) for the contractor. The market analyses may be therefore highly useful and in many cases essential for the contractor to make strategic and/or tactic decisions relating to one or more of its products and/or services with respect to one or more target markets.

The most crucial prerequisite of the automated tasks management service is essentially selecting for execution of each contracted task suitable expert sub-contractors who are knowledgeable, experienced and capable in the knowledge domain of the contracted task in order to ensure a high quality outcome for the contracted task and hence substantial benefit to the satisfaction of the contractor.

However, the automated tasks management service may need to constantly adapt to fluctuations and changes in the pool of expert sub-contractors which may be highly dynamic with resect availability of the expert sub-contractors due to newly introduced expert sub-contractors, temporality unavailable expert sub-contractors and/or the like. In particular, the automated tasks management service needs to constantly scale up to support a continuously increasing expert sub-contractors pool in order to support constant increase in the volume of executed contracted tasks while not compromising their quality. Moreover, the automated tasks management service may need to constantly adapt to varying requirements in the contracted tasks which may affect the methodology, concept and/or guidelines for selecting the expert sub-contractors to execute the contracted tasks. The second prerequisite defined for the automated tasks management service is therefore to constantly adapt and scale.

To meet the two prerequisites, the automated tasks management service may apply an evolving selection algorithm to select one or more expert sub-contractors from a pool of a plurality of expert sub-contractors for executing each contracted task. The evolving selection algorithm may be utilized by one or more ML models, for example, a neural network, a deep neural network, a Support Vector Machine (SVM), a decision tree, a decision forest and/or the like. The evolving selection algorithm may constantly evolve through training and learning to improve its selection performance in order to select knowledgeable, experienced and capable for executing the contracted tasks while continuously adapting and scaling to the increase and changing pool of expert sub-contractors.

In order to constantly evolve following the two prerequisites, the evolving selection algorithm may apply an innovative selection paradigm in which the evolving selection algorithm may be configured to select, from the pool of the plurality of expert sub-contractors, a subset of expert sub-contractors (typically two) for executing each contracted task rather than selecting a single expert sub-contractor. Selecting multiple expert sub-contractors to execute each contracted task establishes a competition model which may drive and motivate the expert sub-contractors to excel and provide high quality outcome to the benefit of the contractors.

At least one of the selected expert sub-contractors of the subset is estimated by the evolving selection algorithm to successfully execute the contracted task and provide a high quality outcome which is compliant with the requirements of the contracted task to the full satisfaction of the contractor.

However, the other expert sub-contractor(s) selected by the evolving selection algorithm to the subset may be selected due to their contribution to enhancement (evolution) of the evolving selection algorithm while possibly estimated with reduced probability to successfully execute the contracted task.

Selecting the subset of expert sub-contractors to execute each contracted task therefore balances and achieves both prerequisites since it includes at least one expert sub-contractor estimated to successfully execute the contracted task thus fulfilling the first prerequisite and at least one expert sub-contractor whose execution of the contracted task is estimated to significantly enhance the evolving selection algorithm and hence promotes the second prerequisite.

The evolving selection algorithm may use one or more methods and/or techniques to select the subset of expert sub-contractors to execute each contracted task, typically based on ranking of the expert sub-contractors and their professional attributes (e.g. knowledge domain, experience, availability, geographical region, previously executed tasks, etc.), specifically with respect to the requirements defined for the contracted task.

The ranking may be computed and/or adjusted for one or more of the expert sub-contractors based on their performance in executing one or more previously contracted tasks. The performance of the expert sub-contractors may be evaluated based on compliance of the outcome delivered expert sub-contractors with the requirements defined for the previously contacted tasks, for example, quality, thoroughness, timing and/or the like. While the ranking may be primarily used for selecting the expert sub-contractors for executing additional contracted tasks, the ranking may be also used for one or more other purposes, for example, establishing reputation of the expert sub-contractors, motivation of the expert sub-contractors and/or the like.

After selecting the subset of expert sub-contractors to execute each contracted task, the automated tasks management service may award (i.e., contract) the contracted task to the selected expert sub-contractors. For example, the automated tasks management service may transmit a message to the client devices, for example, computers, mobile devices and/or the like associate and used by the selected expert sub-contractors.

The automated tasks management service may further assist the contractors in generating a task description for each contracted task to define the requirements, scope and/or other attributes of the contracted task. The tasks management service may outline automatically a guided session, specifically an online guided session followed by the contractor using their client devices to define the task description. The tasks management service may further enhance the task description according to one or more predefined templates, one or more recommendation models and optionally one or ML models trained to extract requirements defined by the contractor and enhance, complement and/or expand the requirements.

In addition, the automated tasks management service may automatically estimate the cost of each such contracted task, specifically with respect to the reward to the expert sub-contractors selected to execute the contracted tasks. The tasks management service may analyze the task description of each contracted task and may estimate a scope of work, for example, an hour's estimate for executing the contracted task. In particular, since the scope of work may vary between different expert sub-contractors, the tasks management service estimates the scope of work for each of the expert sub-contractors of the subset selected to execute each contracted task. As evident the cost estimated for each contracted task comprises the reward to multiple expert sub-contractors, specifically those expert sub-contractors of the selected subset, for example, two expert sub-contractors.

After execution of each contracted task by the selected expert sub-contractors, the automated tasks management service may further automatically compute a split (distribution) of the cost of the contracted task to multiple cost portions each for rewarding (compensating, payment) a respective one of the expert sub-contractors who executed the contracted task.

The tasks management service may typically compute the split of the cost based on the performance of each of the expert sub-contractors which may be quantified by ranking and/or scoring compliance of the outcome and/or the execution process with the requirements defined for the contracted task. However, the tasks management service may adjust the split according to one or more rules in order to more fairly and/or commonly reward the expert sub-contractors who executed each contracted task in order to maintain and desirably increase content, motivation and/or productivity of the expert sub-contractors. The tasks management service may then instruct distribution of the cost portions according to the split to the expert sub-contractors.

In order to ensure commitment of the selected expert sub-contractors to execute each contracted task, the automated tasks management service may condition awarding one or more of the selected expert sub-contractors in agreement of the expert sub-contractor(s) to pay a commitment fee in order to be considered and entitled to receive the contracted task for execution. Obviously, high commitment fees may deter the expert sub-contractors from taking upon themselves contracted tasks while low commitment fees may be insufficient to ensure full commitment of the expert sub-contractors to execute contracted tasks awarded to them. The tasks management service may therefore apply one or more methods, techniques and criteria to compute the commitment fees in order to efficiently harmonize and balance between the need to ensure commitment of the expert sub-contractors estimated to be most relevant for executing the tasks to the satisfaction of the contractors and the need to maintain high responsiveness of the expert sub-contractors to execute the contracted tasks.

The ML models based automated tasks management service may present major advantages and benefits compared to existing methods and systems for contracting tasks to expert sub-contractors.

First, most contractors currently apply manual methods for locating, evaluating and outsourcing their tasks. Such manual methods may be highly limited due to the inherent limitation in resources and ability of the contractor to effectively find suitable expert sub-contractors capable to successfully execute the contracted tasks and evaluate whether these experts are indeed suitable. This limitation is significantly magnified due to the high payment and costs involved in hiring such expert sub-contractors requiring an extensive, through and prolonged identification and evaluation process to ensure a quality outcome and avoid redundant expenses. Moreover, this effort may need to be repeated separately by each of the contractors who obviously do not cooperate with each other thus significantly increasing computing resources, for example, processing resources, storage resources, network resources, time and/or effort to select expert sub-contractors to execute their contracted tasks.

The automated tasks management service on the other hand which is based on the constantly evolving ML models to automatically select the expert sub-contractors for each contracted task may significantly reduce the time, costs and risk for selecting the expert sub-contractors while ensuring high quality of the outcome provided by at least some of the selected expert sub-contractors. The automated tasks management service may therefore significantly reduce the computing resources, time and/or effort required for selecting the expert sub-contractors to execute the tasks contracted by the contractors. The automated tasks management service may further support real-time functionality by communicating in real-time with the contractors and/or the expert sub-contractors. The benefit of the features provided by the automated tasks management service, for example, task description generation, expert sub-contractor selection, cost estimation, cost distribution and/or commitment fee calculation and collection may be thus significantly increased since the solution delivered by the automated tasks management service is rapid, immediate and concise.

Moreover, some of the existing methods may select a single expert sub-contractor to execute each of the contracted tasks, typically the expert sub-contractor estimated to best fit the contracted task and thus estimated to generate a high quality outcome to the benefit of the contractor. This approach may be highly limited to scale for a plurality of contracted tasks since the need to provide high quality outcomes may lead to selecting the same expert sub-contractors over and over again making it unable to evaluate new expert sub-contractors thus stagnating the system. By establishing the competition model in which multiple expert sub-contractors are selected to execute each contracted task, the tasks management service is highly capable of constantly selecting additional expert sub-contractors and evaluating their capabilities. The tasks management service may be therefore highly scalable to accommodate and promote an extremely large number of expert sub-contractors who in turn may be able to successfully execute an extremely large number of contracted tasks to the mutual benefit of the contractors and the expert sub-contractors.

Furthermore, selecting the plurality of expert sub-contractors for each contracted task and establishing the competition model between these expert sub-contractors may significantly increase their motivation and drive to excel and deliver high quality outcome to the benefit of the contractors. This is because the ranking of each of these expert sub-contractors may depend on their performance compared to the other selected expert sub-contractors. The ranking may have a major impact on the distribution of the reward (payment) to the expert sub-contractors who executed the contracted task and the expert sub-contractors may be therefore highly motivated to improve their ranking in order to increase their share of the total reward allocated for the contracted task. Moreover, as the ranking may be a major selection criterion for the expert sub-contractors to be selected to execute future contracted tasks, the ranking may have a major impact on the potential income of each of the expert sub-contractors thus highly motivating the expert sub-contractors to deliver the high quality outcome.

In addition, splitting the cost of the contracted tasks, specifically the cost allocated for reward to the expert sub-contractors selected to execute the task and more so commonly and fairly splitting the reward cost may significantly increase content and motivation of the community (pool) of expert sub-contractors to apply and take on themselves execution of additional contracted task to the benefit of the contractors.

Also, imposing the commitment fee on the expert sub-contractors may ensure that each contracted task is properly executed to the satisfaction of the contractor thus increasing reputation, attractiveness and usage of the automated tasks management service by an ever increasing number of contractors. This in turn may increase the number of contracted tasks which may increase the number of expert sub-contractors recruited to the pool (community) thus further expanding the service and its reputation, attractiveness and usage by additional contractors thus creating a constant expansion of the mated tasks management service.

Applying the ML model(s) for the contracted task's assignment, contraction and reward (compensation) phases, specifically, the expert sub-contractor selection and notification, the cost estimation, the commitment guarantee and the differential reward, each separately and more so for some and potentially all phases combined with feedback and correlation with each other may significantly enhance and optimize the performance of the constantly evolving ML model(s). The various contracted task's assignment, contraction and reward phases may be interdependent and interlinked such that optimizing the ML model(s) according to these interdependencies and correlations may therefore significantly enhance the ML model(s)' performance. The improved ML model(s)' performance may be reflected in significantly reducing the required computing resources by taking advantage of these interdependences, specifically, automatically selecting the most suitable expert sub-contractors, ensuring their commitment in return to the automatically estimated fair reward and further according to the competition model and automatically rewarding them according to their achievement measured by satisfaction of the contractor and optionally adjusted based on system and/or project considerations.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

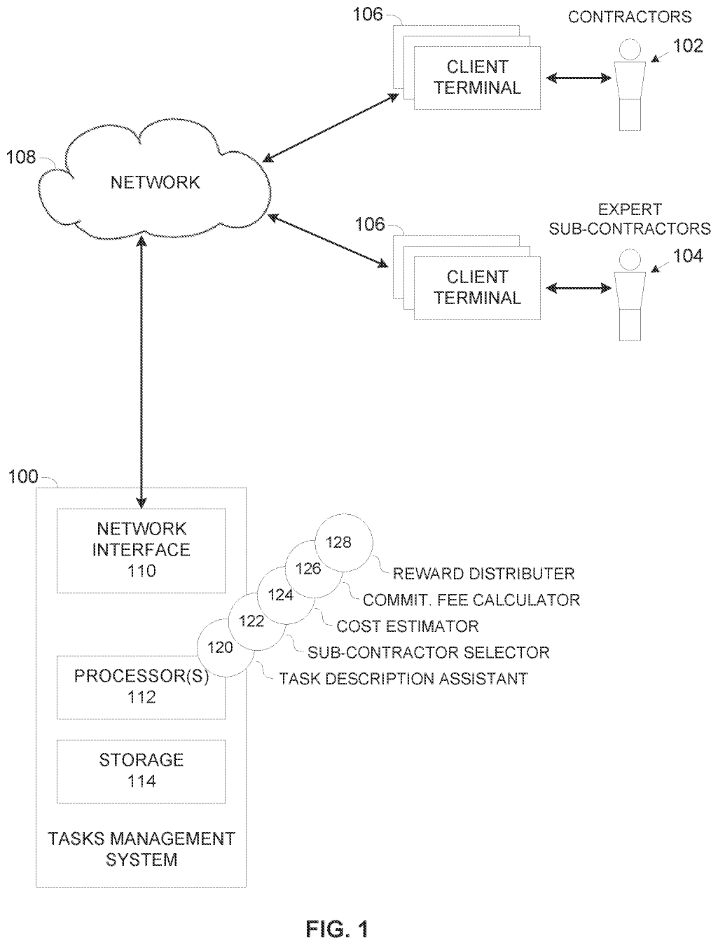

Referring now to the drawings, FIG. 1 is a schematic illustration of an exemplary system for automatically managing tasks contracted by contractors to a plurality of expert sub-contractors, according to some embodiments of the present invention.

A tasks management system 100 may automatically manage a plurality of tasks, for example, jobs, researches, analyses, polls and/or the like contracted (outsourced) by one or more contractors 102, for example, a commercial company (e.g. concern, manufacturer, distributor, importer, exporter, etc.), a government institute, a research organization and/or the like for execution by one or more of a plurality of expert sub-contractors 104, for example, analysts, researchers, domain experts and/or the like.

The tasks management system 100, for example, a computer, a server, a computing node, a cluster of computing nodes and/or the like may include a network interface 110 for connecting to a network 108, a processor(s) 112 and a storage 114 for storing data and/or program (program store).

The network interface 110 may include one or more wired and/or wireless network interfaces for connecting to the network 108 comprising one or more wired and/or wireless networks, for example, a Local Area Network (LAN), a WLAN, a Wide Area Network (WAN), a Wide Area Network (WAN), a Municipal Area Network (MAN), a cellular network, the internet and/or the like. Via the network interface 110, the tasks management system 100 may connect and communicate with remote network resources connected to the network 108, specifically, a plurality of client devices 106 used by the contractors 102 and the expert sub-contractors 104.

The processor(s) 112, homogenous or heterogeneous, may include one or more processors arranged for parallel processing, as clusters and/or as one or more multi core processor(s). The storage 114 may include one or more non-transitory persistent storage devices, for example, a Read Only Memory (ROM), a Flash array, a hard drive and/or the like. The storage 114 may also include one or more volatile devices, for example, a Random Access Memory (RAM) component, a cache memory and/or the like. The storage 114 may further include one or more network storage resources, for example, a storage server, a network accessible storage (NAS), a network drive, a cloud storage and/or the like accessible via the network interface 110.

The processor(s) 112 may execute one or more software modules such as, for example, a process, a script, an application, an agent, a utility, a tool, an algorithm and/or the like each comprising a plurality of program instructions stored in a non-transitory medium (program store) such as the storage 114 and executed by one or more processors such as the processor(s) 112. The processor(s) 112 may further utilize and/or facilitate one or more hardware elements integrated, coupled with and/or utilized by the tasks management system 100, for example, a circuit, a component, an Integrated Circuit (IC), an Application Specific Integrated Circuit (ASIC), a Field Programmable Gate Array (FPGA), a Digital Signals Processor (DSP), an Artificial Intelligence (AI) accelerator and/or the like. The processor(s) 112 may therefore execute one or more functional modules (designated applications herein after) which may be implemented via one or more software modules, one or more of the hardware elements and/or a combination thereof.

For example, the processor(s) 212 may execute a task description assistant application 120 designed and configured to interact with one or more of the contractors 102 to create automatically a task description for each of one or more tasks contracted by one or more of the contractors 102.

In another example, the processor(s) 212 may execute a sub-contractor selector application 122 designed and configured to analyze requirements extracted for each contracted task and automatically select a subset of expert sub-contractors 104 from the plurality of expert sub-contractors 104 to execute each of the tasks contracted by the contractors 102.

In another example, the processor(s) 212 may execute a cost estimator application 124 designed and configured to analyze requirements extracted for each contracted task and automatically estimate the cost of the respective contracted task, specifically the cost estimated for reward to the subset of expert sub-contractors 104 selected to execute the respective task.

In another example, the processor(s) 212 may execute a commitment (commit.) fee calculator application 126 designed and configured to calculate a commitment fee that each expert sub-contractor of the subset selected to execute the respective task is required to pay in order to be potentially awarded execution of the contracted task. An expert sub-contractor of the subset which declines to pay the commitment fee may be therefore excluded from the subset and may not be awarded the contracted task.

In another example, the processor(s) 212 may execute a reward distributer application 128 designed and configured to calculate, for each contracted task, a split of a cost allocated for reward to the subset of expert sub-contractors 104 selected to execute the respective task.

One or more of the applications, i.e., the task description assistant 120, the sub-contractor selector 122, the cost estimator 124, the commitment fee calculator 126 and/or the reward distributer 128 may integrate, use and/or otherwise employ one or more Machine Learning (ML) models as known in the art, for example, a neural network, a Support Vector Machine (SVM), a decision tree and /or the like.

Optionally, the tasks management system 100 and/or one or more of its executed application, for example, the task description assistant 120, the sub-contractor selector 122, the cost estimator 124, the commitment fee calculator 126 and/or the reward distributer 128 may be implemented as one or more cloud computing services, for example, an Infrastructure as a Service (IaaS), a Platform as a Service (PaaS), a Software as a Service (SaaS) and/or the like such as, for example, Amazon Web Service (AWS), Google Cloud, Microsoft Azure and/or the like

The client devices 106, for example, a computer, a tablet, a Smartphone, a terminal and/or the like may be used by the contractors 102 and the expert sub-contractors 104 to interact with the tasks management system 100 and optionally with each other.

Each of the client devices 106 may therefore include one or more network interfaces such as the network interface 110 for connecting to the network 108, one or more processor(s) such as the processor(s) 112 for executing one or more functional modules (applications) and storage such as the storage 114 for storing code and/or data.

Each of the client devices may therefore execute one or more software modules. For example, each client device 106 operated by a respective contractor 102 or an expert sub-contractor 104 may execute one or more local applications, for example, a web browser, a mobile application and/or the like for communicating with the tasks management system 100, specifically with the task description assistant 120, the sub-contractor selector 122, the cost estimator 124, the commitment fee calculator 126 and/or the reward distributer 128.

Each of the client devices 106 may typically include a user interface comprising input and output interfaces to enable interaction with a respective contractor 102 or expert sub-contractor 104 associated and using the respective client device 106. The user interface may include, for example, a screen (display), a touchscreen, a keyboard, a pointing device (e.g. mouse, touch pad, track ball, etc.), a speaker, a microphone and/or the like.

The local application(s) executed by each of the client devices 106 to communicate with the tasks management system 100 may be configured and adapted to present a User Interface (UI), for example, a Graphical UI (GUI) to the contractors 102 and/or the expert sub-contractors 104 via the user interface of the respective client device 106. The GUI may be controlled by the task description assistant 120, the sub-contractor selector 122, the cost estimator 124, the commitment fee calculator 126 and/or the reward distributer 128 to interact with one or more of the contractors 102 and/or the expert sub-contractors 104. Moreover, different GUIs may be constructed and presented to the contractors 102 and to the expert sub-contractors 104 such that one or more first GUIs may be customized for interaction with the contractors 102 and one or more second GUIs may be customized for interaction with the expert sub-contractors 104.

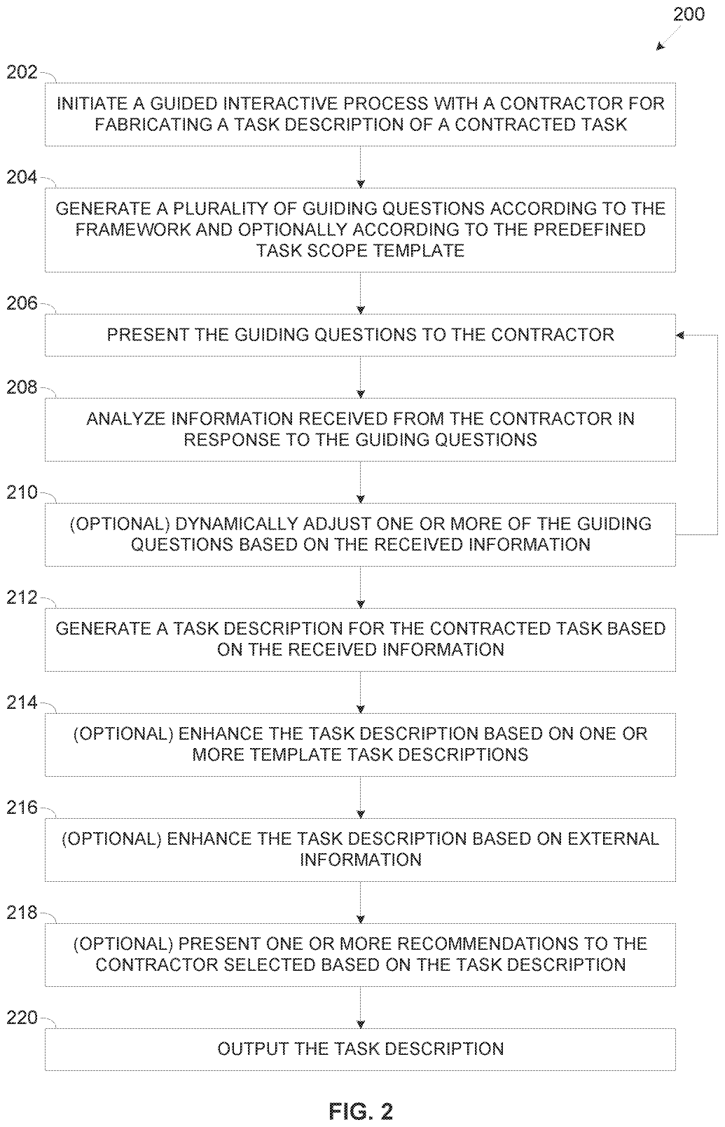

Reference is now made to FIG. 2, which is a flowchart of an exemplary process of automatically creating a task description for a task contracted by a contractor to a plurality of expert sub-contractors, according to some embodiments of the present invention. An exemplary process 200 may be executed by a tasks management system such as the tasks management system 100, specifically by a task description assistant such as the task description assistant 120 to interact with one or more of the contractors such as the contractor 102 to create a task description for each task that the respective contractor 102 intends to contract (outsource) to one or more of the expert sub-contractors such as the expert sub-contractors 104.

It should be noted that the process 200 is described for a single task contracted by a single contractor 102. This however, should not be construed as limiting since the process 200 may be expanded and repeated to interact with a plurality of contractors 102 for a plurality of contracted tasks.

As shown at 202, the process 200 starts with the task description assistant 120 initiating an online guided interactive process to fabricate, interactively with the contractor 102, a task description for a task, for example, an analysis, a market analysis, a research, a study and/or the like the contractor 102 requests to contract (outsource). In particular, the contractor 102 requests to contract the task to one or more of the expert sub-contractors 104, specifically, sub-experts 104 having the knowledge, expertise, experience and/or tools for executing (conducting) the contracted task.

The market analysis, for example, may include analysis and study of the attractiveness and dynamics of a certain market within a special industry. The market analysis may include, for example, identification and characterization of market trends, investigation of customer inclinations and/or the like. The market analysis may further include a study of various customer capabilities, for example, investment attributes, buying potential and/or the like. As such the market analysis may identify Strengths, Weaknesses, Opportunities and Threats (SWOT) of the company (i.e. the contractor 102). The market analysis may be therefore a highly useful and in many cases an essential tool for the contractor 102 to make strategic and/or tactic decisions relating to one or more of its products and/or services with respect to one or more target markets.

The task description assistant 120 may establish and follow the guided interactive process via the UI, for example, the GUI executed by the client device 106 used by the contractor 102 according to instructions issued by the task description assistant 120. Through the online guided interactive process, the task description assistant 120 may create the task description which may comprise a plurality of requirements for the task contracted by the contractor 102, for example, a knowledge domain (e.g. economics, finance, technology, science, etc.), a field (e.g. home appliances, delivery services, drone application(s), pharmaceutical, etc.), a title (e.g. drone based delivery service), an analysis question(s) (e.g. prospects, barriers, competition, etc. for deploying drone based delivery service), a target market segment (e.g. gender, age, preferences, interests, assets, etc.), a scope of work, a target geographical area, a timing requirement (e.g. deadline, schedule, milestones, etc.), preferred expert sub-contractor(s) 104 identified by the contractor 102 and/or the like.

As shown at 204, the task description assistant 120 may generate a plurality of guiding questions to inquire the contractor 102 regarding one or more of the requirements of the contracted task. The task description assistant 120 may generate one or more of the guiding questions according to one or more predefined rules. For example, the task description assistant 120 may use one or more predefined template task descriptions, specifically template task description(s) predefined for the domain identified for the contracted task. For example, assuming the domain indicated by the contractor 102 for the contracted task is drone use for agriculture applications, the task description assistant 120 may use one or more templates created and predefined for this domain and/or for similar domains sharing one or more attributes and/or characteristics with the contracted task.

As shown at 206, the task description assistant 120 may instruct the GUI to present the guiding questions to the contractor 102. In response to these guiding questions, the task description assistant 120 may receive, from the contractor 102, information.

As shown at 208, the task description assistant 120 may analyze the information received from the contractor 102 in response to the guiding questions. Based on the information, the task description assistant 120 may define the requirements of the contracted task to create and/or enhance the task description of the contracted task.

As shown at 210, the task description assistant 120 may optionally create and/or adjust one or more of the guiding questions based on the information received from the contractor 102 in response to one or more of the guiding questions previously presented to the contractor 102 during the online guided interactive process.

The task description assistant 120 may issue and/or adjust one or more new guiding questions based the information received in response to one or more of the previously presented guiding questions according to one or more rules. For example, a certain exemplary rule may dictate that a field and/or a sub-field should be defined for the contracted task to further refine the expertise domain of the contracted task which may improve selection of suitable expert sub-contractors to execute the contacted task. The field and/or a sub-field may be derived from the knowledge domain defined by the contractor 102. In such case, assuming the contractor 102 indicated that the knowledge domain of the contracted task is drone services, the task description assistant 120 may issue a new question requesting the contractor 102 to more specifically define the contracted task in terms of field of the knowledge domain, for example, military applications, commercial applications, agricultural applications and/or the like. The task description assistant 120 may issue further new question(s) requesting the contractor 102 to further focus on the exact nature of the contracted task and define, for example, the sub-field of the contracted task, for example, vassal tracking military applications, package delivery commercial applications, crops monitoring agricultural applications and/or the like. In another example, a certain exemplary rule may dictate that multiple milestones should be defined in case the schedule of the contracted task as defined by the contractor exceeds a period of two weeks. In such case, assuming the contractor 102 indicated that the schedule, for example, a deadline for execution of the contracted task is two months, the task description assistant 120 may issue a new question requesting the contractor 102 to define one or more milestone for execution of the contracted task to break down the two-month period to smaller and easier to track time periods

Optionally, the task description assistant 120 employs one or more of the ML models which may be trained to generate and/or adjust one or more new guiding questions based the information received in response to on one or more previously presented guiding questions. The ML model(s) may be trained using one or more synthetic training datasets created during simulated online guided interactive process(s) and/or real training datasets acquired during one or more past online guided interactive process(s) conducted in the past with one or more of the contractors 102 to create a task description for one or more contracted tasks.

As shown at 212, the task description assistant 120 may generate the task description for the contracted task defining a plurality of the requirements outlined by the contractor 102.

As shown at 214, the task description assistant 120 may optionally use one or more predefined template task descriptions to automatically further enhance the task description created for the contracted task. For example, assuming the target market of the contracted task as indicated by the contractor 102 includes Western Europe. In such case, the task description assistant 120 may enhance the task description of the contracted task to include a geographical segmentation of Western Europe as outlined by one or more of the predefined templates.

As shown at 216, the task description assistant 120 may optionally enhance the task description created for the contracted task based on external information determined by the task description assistant 120 to be related to the contracted task based on analysis of the task description. The task description assistant 120 may retrieve the external information from one or more external resources, for example, networked resources and/or online resources connected to the network 108. For example, assuming the target field of the contracted task as indicated by the contractor 102 includes a market analysis for a certain therapeutic drug for several target geographical areas. Further assuming, that based on analysis of external information retrieved from one or more drug authorities in these target areas the task description assistant 120 determines that the certain therapeutic drug is not allowed for distribution and/or sale in one or more of the target geographical areas. In such case, the task description assistant 120 may adjust the task description, optionally after confirmation with the contractor 102, to exclude the restricted geographical area from the marker analysis.

As shown at 218, the task description assistant 120 may optionally recommend one or more recommendations to the contractor 102 for the contracted task based on analysis of the task description created interactively with the contractor 102. The task description assistant 120 may present to the contractor 102 one or more recommendations selected according to one or more predefined recommendation rules. The task description assistant 120 may select one or more of the recommendations presented to the contractor 102 from one or more external knowledge resources, for example, an online resource identified on the Internet, an online database, a third party expert and/or the like. For example, assuming a certain contractor 102, for example, a commercial company is interested to explore market opportunities in Kenya for fleet management services. The task description assistant 120, based on analysis of one or more fleet management related online resources, may identify that fleets in this region have cross-country characteristics, for example, they provide logistics services for one or more neighboring countries. In such case, the task description assistant 120 may thus recommend the contractor 102 to explore similar market opportunities in one or more of the neighboring countries, for example, Uganda, Tanzania and/or the like.

The task description assistant 120 may further present to the contractor 102 one or more recommendations selected based on a dynamic recommendation model created based on a plurality of previously contracted tasks executed in the past by one or more of the expert sub-contractors 104. The dynamic recommendation model may be created and enhanced based on analysis of previous sessions for creating the task description for one or more previous contracted tasks sharing at least some similarity with the task description of the current contracted task.

For example, assuming that multiple and possibly most past contractors 102 who were interested in a certain domain A for a plurality of previous contracted tasks also showed interest in a certain component B. The recommendation model may be therefore updated to correlate between the domain A and the component B. In case the task description assistant 120 interacting with the contractor 102 for the currently contracted task identifies that the contractor 102 is interested in the domain A, the task description assistant 120, based on the recommendation model, may recommend the contractor 102 to further explore the component B. In another example, assuming that multiple and past contractors 102 who were interested in a certain domain C for a plurality of previous contracted tasks also requested to explore information relating to several market players (companies, participants, competitors, etc.) X, Y, Z who are active in domain C. The recommendation model may be updated accordingly to correlate between the domain C and the market players X, Y, Z. In case the task description assistant 120 interacting with the contractor 102 for the currently contracted task identifies that the contractor 102 is interested in the domain C, the task description assistant 120, based on the recommendation model, may recommend the contractor 102 to further explore the market players X, Y, Z.

The recommendation model may be further updated according to the outcome of one or more previous contracted tasks. For example, assuming that one or more of the past contractors 102 who explored the domain A and further the component B were not satisfied with the results received for the component B, in particular with respect to the domain A which was their primary interest. In such case, the recommendation model may be further updated to eliminate (delete) the correlation between the domain A and the component B such that other contractors 102 identified to be interested in the domain A are not presented with a recommendation to further explore the component B.

As shown at 220, the task description assistant 120 may output, for example, transmit, deliver and/or otherwise provide the task description created for the contracted task. For example, the task description assistant 120 may provide the task description to the sub-contractor selector 122 and/or to the cost estimator 124.

The sub-contractor selector 122 receiving the task description may analyze it and select a subset comprising multiple of expert sub-contractors 104 from the plurality of expert sub-contractors 104 to execute the contracted task. In particular, the sub-contractor selector 122 may apply an evolving selection algorithm to select the subset of expert sub-contractors 104 in order to ensure two main prerequisites.

The first prerequisite is to ensure a high quality outcome for the contracted task, for example, an analysis report, a research report, experiments results and/or the like to the satisfaction of the contractor 102. To this end the evolving selection algorithm selects the subset such that at least one of the expert sub-contractors 104 of the subset is estimated with high probability to successfully execute the contracted task.

The second prerequisite relates to the need for constant evolution and enhancement of the evolving selection algorithm itself in order to adapt to a plurality of dynamic conditions relating to the expert sub-contractors 104, for example, availability, capabilities, ambition, responsiveness and/or the like. Enhancing the evolving selection algorithm may enable it to, for example, support expansion of the pool of available expert sub-contractors 104, adapt to unavailability conditions in which one or more of the expert sub-contractors 104 are unavailable, identify capable and incapable expert sub-contractors 104 among the plurality of expert sub-contractors 104, identify high motivation and low motivation expert sub-contractors 104 and/or the like. To this end the evolving selection algorithm selects the subset to include one or more expert sub-contractors 104 whose execution of the contracted task and/or offering them the contracted task is estimated with high probability to enhance and improve the evolving selection algorithm.

It should be notes that the two prerequisites may sometimes conflict with each other at least to some degree and the evolving selection algorithm may therefore apply one or more methods, techniques and/or paradigms to select an optimal subset in which combination of the two prerequisites may present maximal gain.

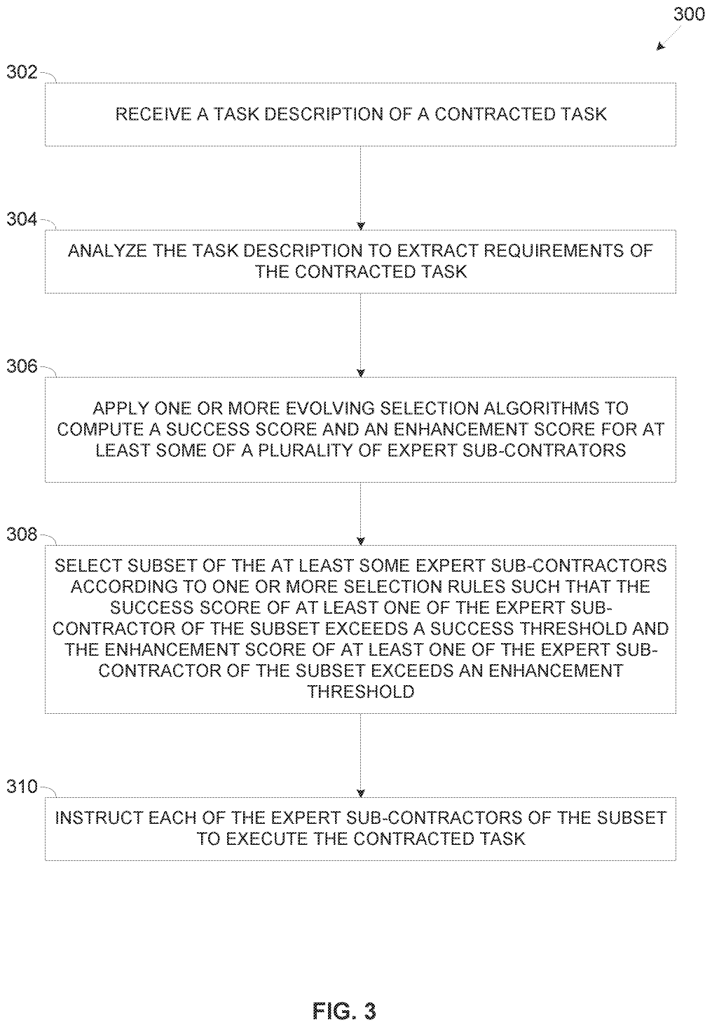

Reference is now made to FIG. 3, which is a flowchart of an exemplary process of automatically selecting a subset from a plurality of expert sub-contractors to execute a task contracted by a contractor, according to some embodiments of the present invention. An exemplary process 300 may be executed by a tasks management system such as the tasks management system 100, specifically by a selection algorithm such as the sub-contractor selector 122 to automatically select a subset of expert subcontractors such as the expert sub-contractors 104 to execute a task contracted by a contractor such as the contractor 102.

It should be noted that the process 300 is described for a single task contracted by a single contractor 102. This however, should not be construed as limiting since the process 300 may be expanded and repeated to select expert sub-contractors 104 for a plurality of contracted tasks.

As shown at 302, the process 300 starts with the sub-contractor selector 122 receiving the task description of the task contracted (outsourced) by the contractor 102 for execution by one or more expert sub-contractors such as the expert sub-contractors 104. For example, the sub-contractor selector 122 may receive the task description created by the task description assistant 120 iteratively with the contractor 102 during the online guided interactive process.

As shown at 304, the sub-contractor selector 122 may analyze the task description to extract the plurality of requirements defined in the task description for the contracted task created as described in the process 200.

As shown at 306, the sub-contractor selector 122 may apply an evolving selection algorithm designed, configured and trained to compute a success score and an enhancement score for at least some of the plurality of expert sub-contractors 104. The success score computed for the respective expert sub-contractor 104 may indicate the estimated probability that the respective expert sub-contractor 104 will successfully execute the contracted task according to the requirements extracted from the task description. The enhancement score computed for the respective expert sub-contractor 104 may indicate the estimated enhancement to the evolving selection algorithm which may result from the contracted task being executed by the respective expert sub-contractor 104.

The evolving selection algorithm may be implemented and/or utilized using one or more of the ML models such as, for example, the neural network, the SVM, the decision tree and/or the like. The evolving selection algorithm may be trained (learned) to compute the success score and the enhancement score for the expert sub-contractors 104 using one or more training datasets. The training dataset(s) may include a plurality of training tasks evaluated for execution by the plurality of expert sub-contractors 104 coupled with respective outcomes of execution of each of the plurality of training tasks by one or more of the plurality of expert sub-contractors 104. The training datasets may include simulated data and/or real data. The simulated data may originate from simulated training task coupled with respective outcomes received from simulated expert sub-contractors such as the expert sub-contractors 104. The real data however may be retrieved after the evolving selection algorithm is deployed from real contracted tasks coupled with the outcomes received from at least some of the plurality of expert sub-contractors 104.

The evolving selection algorithm may compute the success score for each of the at least some expert sub-contractors 104 according to compliance and/or match of one or more expert attributes of the respective expert sub-contractor 104 with the requirements of the contracted task. The expert attributes may include, for example, a ranking score of the respective expert sub-contractor 104 and/or one or more professional attributes of the respective expert sub-contractor 104.

The ranking score which may be used to compute the success score may be computed, adjusted and/or updated for each expert sub-contractor 104 who executed one or more previous contracted tasks in the past. The ranking score may be computed adjusted and/or updated by one or more of the software modules executed by the tasks management system 100, for example, the sub-contractor selector 122 and/or one or more of the evolving selection algorithm employed by the sub-contractor selector 122.

The ranking score may be computed based on a compliance score computed for an outcome of each of the previous contracted executed by the respective expert sub-contractor 104. The compliance score is computed for the respective expert sub-contractor 104 for each previous contracted task based on one or more outcome parameters of the outcome, for example, quality (e.g. professionalism, expertise, thoroughness, accuracy, etc.) in compliance with the required goals (analysis/research question(s), scope, etc.), compliance with one or more of the timing requirement (e.g., deadline, schedule, milestones, etc.) defined for the respective previous contracted task, responsiveness of the respective expert sub-contractor 104 during the execution of the respective previous contracted task and/or the like.

For example, assuming a first expert sub-contractor 104 executed a previous task and received a high compliance score since he delivered a high quality outcome

The outcome parameters used to compute the compliance score for each of one or more of the expert sub-contractor 104 may be extracted from one or more sources and/or records relating to each of the previous contracted tasks executed by the respective expert sub-contractor 104. For example, one or more of the outcome parameters may be extracted from a feedback received from a contractor 102 of the respective previous contracted task for the outcome received from the respective expert sub-contractor104. For example, a certain contractor 102 who contracted a previous contracted task executed by two of the expert sub-contractors 104 may have generated a feedback record comprising a satisfaction (level) score of the certain contractor 102 with the outcome received from each of the two expert sub-contractors 104 with respect to the outcome quality, their compliance with schedule, their responsiveness and/or the like.

In another example, one or more of the outcome parameters may be extracted from a professional review conducted for the outcome received from the respective expert sub-contractor 104 for the respective previous contracted task. The professional review may be executed by one or more people who are professionals, specifically in the domain of the respective previous contracted task. In another example, the professional review may be executed by one or more of the other expert sub-contractors 104 contracted to evaluate the outcome of one or more of the expert sub-contractors who executed the respective previous contracted task.

In another example, one or more of the outcome parameters may be extracted based on an automatic analysis of the outcome received from the respective expert sub-contractor 104 for the respective previous contracted task. For example, one or more automated tools, for example, a Natural Language Processing (NLP) tool may be applied to the outcome received from one or more of the expert sub-contractors 104 for the respective previous contracted task to extract one or more of the compliance parameters and compute a compliance score for them. In another example, one or more tracking tools may be applied to track compliance of one of more of the expert sub-contractors 104 with the timing requirements defined for the respective previous contracted task.

The sub-contractor selector 122, specifically the evolving selection algorithm may be further configured to apply a relative ranking by adjusting the ranking score of one or more of the expert sub-contractor 104 with respect to the ranking score of one or more other expert sub-contractors 104 according to one or more ranking parameters. Using the relative score may serve to reflect the activity in the knowledge domain of the currently contracted task such that expert sub-contractors 104 may be ranked according to their activity level in previous contracted tasks of the same knowledge domain as the currently contracted task. For example, expert sub-contractors 104 who were highly active (conducted multiple tasks) in the knowledge domain of the currently contracted task may be ranked differently compared to other expert sub-contractors 104 who were not very active (conducted no or few tasks) in the knowledge domain of the currently contracted task.

The ranking parameters may include, for example, a number of previous contracted tasks executed by one or more of the plurality of expert sub-contractors 104 in the knowledge domain of the currently contracted task, an aggregated compliance score computed for one or more of the plurality of expert sub-contractors 104 based on their execution of a plurality of previous contracted tasks in the knowledge domain of the contracted task, a number of expert sub-contractors available in the knowledge domain of the contracted task and/or the like. For example, the evolving selection algorithm may compute higher ranking scores for expert sub-contractors 104 who computing lower ranking scores for expert sub-contractors 104 who received low compliance scores for their execution of previous contracted tasks. In another example, the evolving selection algorithm may compute a relatively high ranking score for one or more expert sub-contractors 104 which are experts in a knowledge domain in which there are very few experts. In contrast, the evolving selection algorithm may compute a relatively low ranking score for one or more expert sub-contractors 104 which are experts in a knowledge domain in which there are many experts.

Optionally, the sub-contractor selector 122, specifically the evolving selection algorithm may be configured to adjust the ranking, specifically the relative ranking of one or more of the expert sub-contractors 104 according to one or more parameters of the contacted tasks previously executed in the past by the respective expert sub-contractor 104. For example, the evolving selection algorithm may adjust the relative ranking of a one or more of the expert sub-contractors 104 according to a cost of one or more previously contracted tasks executed by the expert sub-contractor(s) 104 in the past, specifically according to value of the payment paid to the expert sub-contractor(s) 104 for the execution of the previously contracted task(s). For example, the higher the payment value for a previously contracted task, the higher is the ranking computed by the evolving selection algorithm for a first expert sub-contractor 104 who successfully executed the previously contracted task. In contrast, the evolving selection algorithm may compute a lower ranking for a second expert sub-contractor 104 who executed a previously contracted task which was priced at a lower price even if the second expert sub-contractor 104 successfully executed it.

In another example, the evolving selection algorithm may adjust the relative ranking of one or more of the expert sub-contractors 104 according to performance of the expert sub-contractor(s) 104 in execution of one or more previously contracted tasks. For example, the evolving selection algorithm may increase the relative ranking of a first expert sub-contractor 104 who executed more contracted tasks in a recent period of time (e.g. this year) compared to a past corresponding period of time (e.g. last year). In contrast, the evolving selection algorithm may decrease (reduce) the relative ranking of a second expert sub-contractor 104 who executed less contracted tasks in the recent period of time compared to the past corresponding period of time.

In another example, the evolving selection algorithm may adjust the relative ranking of one or more of the expert sub-contractors 104 according to the other expert sub-contractor(s) 104 who executed one or more previously contracted tasks also executed by the respective expert sub-contractor(s) 104. For example, the evolving selection algorithm may increase the relative ranking of a first expert sub-contractor 104 who executed one or more previously contracted tasks which were also executed in parallel by another high ranking expert sub-contractor 104, specifically in case the first expert sub-contractor 104 successfully executed the previously contracted task(s). In contrast, the evolving selection algorithm may decrease (reduce) the relative ranking of a second expert sub-contractor 104 who executed one or more previously contracted tasks which were also executed in parallel by another low ranking expert sub-contractor 104, specifically in case the second expert sub-contractor 104 failed to successfully execute one or more of the previously contracted task(s).

The primary use of the ranking is for the sub-contractor selector 122 using it for selecting expert sub-contractors 104 for executing contracted tasks. However, the ranking may be further used for one or more other purposes, for example, establishing and reflecting reputation of the expert sub-contractors 104, motivating the expert sub-contractors 104 and/or the like. For example, gaining prestige and esteem, the ranking may serve to express reputation of the expert sub-contractors in their community as well as to others, for example, the contractors who may condition their selection of expert sub-contractors on their established reputation.

The professional attributes which may be used to compute the success score for one or more of the expert sub-contractors 104 may include, for example, age, gender, a knowledge domain, experience, language, geographical location, expected reward for executing the contracted task, availability, an influence evaluated for the respective expert sub-contractor 104 on one or more other expert sub-contractors 104 and/or the like. For example, a higher ranking score may be computed for a first expert sub-contractor 104 identified to be an expert in the knowledge domain of the contracted task compared to the ranking score computed for a second expert sub-contractor 104 who is identified to be an expert in a knowledge domain different from that of the contracted task. In another example, a higher ranking score may be computed for a first expert sub-contractor 104 identified to be available in during the time period defined by the requirements for execution of the contracted task compared to the ranking score computed for a second expert sub-contractor 104 who is identified to be unavailable during this time period, for example, due to other engagements, high work load, national holidays and/or the like. In another example, a higher ranking score may be computed for a first expert sub-contractor 104 identified to reside and/or operate in the geographical area overlapping with the geographical area targeted by the contracted task compared to the ranking score computed for a second expert sub-contractor 104 who is identified to reside and/or operate in a different geographical area. In another example, a higher ranking score may be computed for a first expert sub-contractor 104 identified to have major influence over other expert sub-contractors 104, for example, through a blog, through frequent publications and/or the like compared to the ranking score computed for a second expert sub-contractor 104 having no such influence.

The sub-contractor selector 122 may extract the professional attributes of the expert sub-contractors 104 from one or more resources, in particular one or more online resources. For example, one or more of the professional attributes of one or more of the expert sub-contractors 104 may be extracted from one or more public online resources such as, for example, a social network (e.g. LinkedIn, Facebook, etc.) which are publicly accessible. However, one or more of the professional attributes of one or more of the expert sub-contractors 104 may be extracted from one or more private online resources such as, for example, a database comprising private data which are not publicly accessible.

Optionally, one or more of the professional attributes used to compute the success score are assigned weights to reflect their importance and contribution to the overall success score computed for one or more of the expert sub-contractors 104. For example, a higher weight may be assigned to the experience attribute of a certain expert sub-contractor 104 compared to the weight assigned to the age attribute of the certain expert sub-contractor 104.

The evolving selection algorithm may compute the enhancement score for each of the at least some expert sub-contractors 104 according to one or more past engagement parameters identified for the respective expert sub-contractor 104. The past engagement parameters may reflect system and/or project considerations relating to the overall operation and performance of the evolving selection algorithm.

The past engagement parameters identified for the one or more of the expert sub-contractors 104 may include, for example, a number of offers submitted to the respective expert sub-contractor 104 for executing previous contracted tasks, a number of offers accepted by the respective expert sub-contractor 104 for executing previous contracted tasks, a number of previous contracted tasks submitted to the respective expert sub-contractor 104 for execution, a reward range of previous contracted tasks accepted or declined by the respective expert sub-contractor 104, a trend of the reward range accepted or declined by the respective expert sub-contractor 104, a knowledge domain of previous contracted tasks accepted or declined by the respective expert sub-contractor 104 and/or the like.

For example, a first expert sub-contractor 104 who recently joined the pool of the expert sub-contractors 104 may have executed no or very few contracted tasks and therefore his capabilities, motivation, responsiveness and/or the like may not have been evaluated yet and hence may be unknown. As such, the first expert sub-contractor 104 may not be ranked or may have a default ranking score which may prevent the evolving selection algorithm to correctly and/or accurately compute an estimated success score for the first expert sub-contractor 104. The evolving selection algorithm may therefore compute a relatively high enhancement score for the first expert sub-contractor 104 since by executing the contracted task additional information may be collected for the first expert sub-contractor 104 which may be used to update the ranking score of the first expert sub-contractor 104. This may naturally enhance performance of the evolving selection algorithm which may be able to more accurately compute the ranking score of the first expert sub-contractor 104 for one or more future contracted tasks. In contrast, a second expert sub-contractor 104 who executed a large number of contracted tasks may have his capabilities well known and he may be thus accurately ranked among the plurality of expert sub-contractors 104. The evolving selection algorithm may therefore compute a relatively low enhancement score for the second expert sub-contractor 104 because execution of the contracted task by the second expert sub-contractor 104 may provide relatively little new information and may therefore be of little benefit for the evolving selection algorithm.

In another example, a first expert sub-contractor 104 may have been selected and offered to execute multiple previous contracted tasks but declined most of the offers. The reason(s) for the first expert sub-contractor 104 declining of the offers, for example, low reward, short schedule, unavailability and/or the like may be unknown and therefore unmapped for the evolving selection algorithm which may be unable to properly select the first expert sub-contractor 104 for executing contracted tasks. The evolving selection algorithm may therefore compute a relatively high enhancement score for the first expert sub-contractor 104 since by offering the first expert sub-contractor 104 to execute the contracted task for a certain reward, in a certain schedule and/or the like may provide additional information. The additional information may enable the evolving selection algorithm to better map the preferences of the first expert sub-contractor 104 thus enhancing the performance of the evolving selection algorithm. In contrast, a second expert sub-contractor 104 who was offered a large number of previous contracted tasks and executed some while rejecting others may be well mapped by the evolving selection algorithm with respect to his preferences. Execution of the contracted task by the second expert sub-contractor 104 may therefore yield little benefit to the evolving selection algorithm which may therefore compute a relatively low enhancement score for the second expert sub-contractor 104.

The evolving selection algorithm may further compute the enhancement score for one or more of the expert sub-contractors 104 based on an estimated source cause which led the respective expert sub-contractor 104 to exhibit one or more of the past engagement parameters identified for the respective expert sub-contractor 104 with respect to one or more previous contracted tasks. The estimated source cause may include, for example, a type of the knowledge domain of the previous contracted task(s), a value of the reward offered for executing the previous contracted task(s), availability or unavailability due to personal reasons, availability or unavailability due to cultural reasons, confidence of the at least one expert sub-contractor in the selection process and/or the like.

For example, assuming a first expert sub-contractor 104 was offered a plurality of previous contracted tasks in a certain knowledge domain and accepted some while rejecting others. Further assuming that the previous contracted tasks accepted by the first expert sub-contractor 104 entailed a relatively high reward while the previous contracted tasks declined by the first expert sub-contractor 104 entailed a relatively low reward. In such case, the evolving selection algorithm may estimate with high confidence that the source cause for declining the previous contracted task is the reward value. Awarding the contracted task to the first expert sub-contractor 104 may therefore yield little benefit to the evolving selection algorithm which may thus compute a relatively low enhancement score for the first expert sub-contractor 104. In contrast, in case the evolving selection algorithm is unable to estimate with high confidence the source cause for declining previous contracted tasks by a second expert sub-contractor 104, the evolving selection algorithm may compute a relatively high enhancement score for the second expert sub-contractor 104 since awarding the contracted task to the second expert sub-contractor 104 may further map the source cause for the second expert sub-contractor 104 declining of contracted tasks.

The evolving selection algorithm may further compute the enhancement score for one or more of the expert sub-contractors 104 based on an estimated future demand for executing a plurality of future contracted tasks. The evolving selection algorithm may estimate the future demand is estimated based on one or more trends and/or areas of interest identified in a plurality of previous contracted tasks, for example, a knowledge domain trend, a reward range trend, targeted geographical area(s), targeted market segment(s) and/or the like.

For example, assuming that based on a plurality of previous contracted tasks, the evolving selection algorithm determines that a large number of previous contracted tasks were focused on a certain knowledge domain, for example, cyber security. In such case, the evolving selection algorithm may attempt to identify and map as many as possible expert sub-contractors 104 who are capable of executing contracted tasks in the cyber security knowledge domain. The evolving selection algorithm may therefore compute a relatively high enhancement score for one or more expert sub-contractors 104 who are identified to be experts in the cyber security knowledge domain in attempt to better map capabilities, availability and/or preferences of these expert sub-contractor(s) 104. In contracts the evolving selection algorithm may compute a relatively low enhancement score for one or more expert sub-contractors 104 who are identified to be experts in knowledge domain(s) other than cyber security since such expert sub-contractor(s) 104 are less relevant to the growing trend of contracted tasks in the cyber security knowledge domain.

In another example, assuming that based on a plurality of previous contracted tasks, the evolving selection algorithm determines that a large number of previous contracted tasks were focused on a certain geographical area, for example, South America. In such case, the evolving selection algorithm may attempt to identify and map as many as possible expert sub-contractors 104 who are capable of executing contracted tasks focused on South America. The evolving selection algorithm may therefore compute a relatively high enhancement score for one or more expert sub-contractors 104 who are identified to be experts in the South America region in attempt to better map capabilities, availability and/or preferences of these expert sub-contractor(s) 104. In contracts the evolving selection algorithm may compute a relatively low enhancement score for one or more expert sub-contractors 104 who are identified to be experts in geographical area(s) other than South America since such expert sub-contractor(s) 104 are less relevant to the growing trend of contracted tasks focused on South America.

Optionally, one or more of the future demands may be estimated manually by one or more experts, for example, market analysists, technological experts and/or the like. The estimated future demand(s) may be inserted to the evolving selection algorithm which may use the estimated future demand(s) to compute the enhancement score for one or more of the expert sub-contractors 104 evaluated for execution of one or more contracted tasks.

Optionally, the evolving selection algorithm evaluates one or more unlisted expert sub-contractors which are not listed in the pool of expert sub-contractors 104 and computes their success score and optionally their enhancement score. In particular, the evolving selection algorithm may evaluate the unlisted expert sub-contractor(s) in case of little or no availability of expert sub-contractors 104 having a sufficiently high success score to ensure successful execution of the contracted task.

The evolving selection algorithm may identify the unlisted expert sub-contractors using one or more methods. For example, the evolving selection algorithm may identify one or more unlisted expert sub-contractors by exploring and analyzing one or more online resources connected to the network 108, for example, a web site, a social media platform (e.g. LinkedIn, Facebook, etc.), an online service (e.g. experts' database, hiring service, academic institution graduates' database, etc.) and/or the like. The evolving selection algorithm may analyze the online resource(s) to extract the professional attributes of one or more of the unlisted expert sub-contractors, for example, an academic degree, an expertise knowledge domain, a professional resume, a track record and/or the like. In another example, the evolving selection algorithm may identify one or more of the unlisted expert sub-contractors recommended by one or more of the expert sub-contractors 104 who are registered and listed in the tasks management system 100. For example, the evolving selection algorithm may analyze a recommendation form filled by one or more of the expert sub-contractors 104 to recommend one or more unlisted expert sub-contractors to extract the professional attributes of the respective unlisted expert sub-contractor(s). The evolving selection algorithm may further compute an estimated success score for the unlisted expert sub-contractor(s) according to their professional attributes with respect to requirements of the contracted task.

Optionally, the evolving selection algorithm evaluates one or more expert sub-contractors 104 identified as experts in a knowledge domain different from the knowledge domain of the contracted task and computes their success score and enhancement score.

In particular, the evolving selection algorithm may evaluate such expert sub-contractor(s) 104 of the different knowledge domain in case of little or no availability of expert sub-contractors 104 expert in the knowledge domain of the contracted task. The evolving selection algorithm may select the expert sub-contractor(s) 104 of the different knowledge domain for evaluation according to at least a partial match between one or more of their professional attributes with respect to requirements of the contracted task. Based on their at least partial match, the evolving selection algorithm may estimate that the selected expert sub-contractors 104 may successfully execute the contracted task even though it is not in their specific knowledge domain.

For example, assuming the knowledge domain of the contracted task is drones use for agriculture applications. Further assuming the evolving selection algorithm is unable to identify expert sub-contractors 104 that are experienced and/or skilled for executing contracted tasks in the drones use for agriculture applications knowledge domain. In such case, the evolving selection algorithm may evaluate one or more expert sub-contractors 104 having professional attributes which match at least partially the drones use for agriculture knowledge domain, for example, expert sub-contractors 104 in one or more adjacent and/or overlapping knowledge domains such as, for example, drones use for traffic control, drones use for search and rescue services and/or the like.

The evolving selection algorithm may also select to the subset one or more expert sub-contractors 104 from a different knowledge domain to overcome and/or compensate for one or more possible requirements definition errors included in the task description during the interactive construction of the task description with the contractor 102 as described in the process 200. For example, assuming that the evolving selection algorithm determines and/or estimates that based on the knowledge domain defined in the task description of the contracted task, another certain requirement defined in the task description, for example, a professional expertise is wrongly defined. In such case, the evolving selection algorithm may select one or more expert sub-contractors 104 having a different professional expertise, in particular a professional expertise estimated to be relevant for the contracted task, for example, based on analysis of the knowledge domain defined for the contracted task in the task description. Moreover, in such case the commitment fee computed for these selected expert sub-contractors 104 as described herein after may be adjusted, specifically increased. This may be done to increase the confidence that the selected expert sub-contractors 104 are highly committed to execute the contracted task which may potentially require additional effort since their (the expert sub-contractors 104) professional expertise is somewhat different from what is required to successfully execute the contracted task.

As shown at 308, the sub-contractor selector 122 may select a subset of expert sub-contractors 104, for example, two expert sub-contractors 104, three expert sub-contractors 104 and/or the like according to the success score and/or enhancement score computed for these expert sub-contractors 104 by the evolving selection algorithm.

In particular, the sub-contractor selector 122 may select the subset of expert sub-contractors 104 according to one or more selection rules defined to achieve an optimal combination (and potentially an optimal compromise) of the two prerequisites of ensuring high quality outcome for the contracted task to the satisfaction of the contractor 102 and pushing for constant evolution and enhancement of the evolving selection algorithm to adapt to the dynamic conditions relating to the expert sub-contractors 104.

The selection rule(s) may be therefore defined for selecting the subset such that at least one of the expert sub-contractors 104 of the subset is estimated with high probability to successfully execute the contracted task according to the requirements of the contracted task. The selection rule(s) may be further defined to dictate selection to the subset at least one expert sub-contractor 104 whose execution of the contracted task and/or offering him the contracted task is estimated with high probability to contribute to enhancement of the evolving selection algorithm.

The selection rule(s) may define a first threshold defined to ensure a minimal success probability of at least one expert sub-contractor 104 of the subset to successfully execute the contracted task in compliance with the plurality of requirements. The selection rule(s) may also define a second threshold defined to ensure a minimal probability of the evolving selection algorithm to enhance based on an outcome of the execution of the contracted task by at least one of the expert sub-contractor 104 of the subset and/or by offering the contracted task to the at least one of the expert sub-contractor 104 of the subset.

The enhancement to the evolving selection algorithm may be defined by one or more enhancement parameters. The enhancement parameters may include, for example, computing an initial success score and/or an initial enhancement score for one or more new expert sub-contractor added to the pool of expert sub-contractors 104. In another example, the enhancement parameters may include adjusting the success score and/or the enhancement score of one or more of the plurality of expert sub-contractors 104. In another example, the enhancement parameters may include enhancing one or more grouping algorithms used by the evolving selection algorithm to select one or more expert sub-contractors 104 as candidates for executing one or more future contracted tasks.

Moreover, the selection rule(s) may be defined to balance between the first and second thresholds in order to select the subset to include expert sub-contractors 104 which result in maximum enhancement of the evolving selection algorithm while ensuring successful execution of the contracted task in compliance with the requirements defined for the contracted task.

Optionally, the sub-contractor selector 122 selects one or more expert sub-contractors 104 who do not comply with any of the two thresholds. This may be done, for example, in case of limited or unavailability of expert sub-contractors 104 estimated to successfully execute the task with a very high confidence level. Moreover, in such case the commitment fee computed for these selected expert sub-contractors 104 as described herein after may be adjusted, specifically increased. This may be done to increase the confidence that the selected expert sub-contractors 104 are highly committed to execute the contracted task which may potentially require additional effort since the expert sub-contractors 104 may not be most highly suitable to execute it.

As shown at 310, the sub-contractor selector 122 may instruct each of the expert sub-contractors 104 selected in the subset to execute the contracted task. For example, the sub-contractor selector 122 may transmit the task description of the contracted task to the client terminal 106 associated with and used by each of the selected expert sub-contractors 104 and further transmit them a request to execute the contracted task according to the requirements outlined in the task description.

It should be emphasized that each of the expert sub-contractors 104 of the subset who is awarded (instruct to execute) the contracted task executes the contracted task independently of the other expert sub-contractors 104. Selecting multiple expert sub-contractors 104 for executing the contracted task may establish a competition model which may significantly increase the motivation, drive and/or commitment of each of the selected subset of expert sub-contractors 104 to excel and provide high quality outcome to the contracted task in compliance with the task requirements defined for the contracted task. This is because each of the selected expert sub-contractors 104 is aware that one or more other expert sub-contractors 104 are selected to execute the same contracted task and the performance of the selected expert sub-contractors 104 will be evaluated with respect to each other thus affecting his ranking and thus his probability to be selected to execute future contracted tasks thus having a major impact on his potential future income. Moreover, as described herein after, the ranking may have a major impact on the distribution of the reward (payment) to the expert sub-contractors 104 selected to execute the (current) contracted task and the selected expert sub-contractors 104 may be therefore highly motivated to improve their ranking in order to increase their share of the total reward (cost of the contracted task allocated for payment) allocated for the current contracted task.

Optionally, the sub-contractor selector 122 stipulates selecting one or more of the expert sub-contractors 104 to the subset in agreement of the respective expert sub-contractor(s) 104 commit to complete execution of the contracted task by to paying a commitment fee. The commitment fee may be computed by a commitment fee calculator such as the commitment fee calculator 126 as described in detail herein after.

The sub-contractor selector 122 may transmit a payment request to each of one or more of the expert sub-contractors 104 selected to the subset. For example, the sub-contractor selector 122 may transmit the payment request to the client terminal 106 associated with each of the selected expert sub-contractors 104.

The sub-contractor selector 122 may then instruct each expert sub-contractor 104 of the subset who paid the commitment fee (if requested) to execute the contracted task and may exclude each sub-contractor 104 who did not pay the commitment fee (if requested) from the subset. Moreover, in case the sub-contractor selector 122 excludes one or more of the sub-contractors 104 from the subset, the sub-contractor selector 122 may adjust the selection of the expert sub-contractors 104 to the subset according to the selection rule(s) to include one or more other expert sub-contractors 104 to replace the excluded expert sub-contractor(s) 104.

Ensuring high quality outcome may be the more critical prerequisite having priority over the second prerequisite since the satisfaction of the contractors 102 is essential to establish trust in the tasks management system 100 and service. The success value expressed by the success score may be computed according to an approximate probability calculation as shown in equation 1 below where:
P1 is the approximate probability of the selected sub-contractor 104 to generate a high quality outcome for the contracted task.
P2 is the approximate probability of the selected expert sub-contractor 104 to generate a high quality outcome for the contracted task adjusted by the influence of the commitment of the selected expert sub-contractor 104 to execute the contracted task by paying the commitment fee.
X is the approximate probability of the selected sub-contractor 104 to generate a high quality outcome for the contracted task adjusted by the of a competition model with respect to one or more other expert sub-contractors 104 selected for the contracted task.
Y is the approximate probability the selected expert sub-contractor 104 to generate a high quality outcome for the contracted task adjusted by the influence of the ranking of the selected expert sub-contractor 104.
It should be noted that there may be some interdependence between the computed probabilities which may require some adjustment and/or adaptation of the formulation expressed in equation 1 to compensate for such potential interdependencies.

Evolving Selection Competition Algorithm Commitment Model Ranking (1−P1)*(1−P2)*(1−X%)*(1−Y%)=Success Value Equation 1:

The selection rule(s) may therefore define the first threshold to guarantee high quality outcome from at least one of the expert sub-contractors 104 selected to the subset. Equation 2 below presents exemplary values defined by a certain selection rule for the formulation of equation 1 to ensure that the selected sub-contractors 104 generate high quality outcomes for the contracted task. As would be appreciated by a person skilled in the art, other exemplary values may be applied in equation 2 and moreover, a different formulation may be used to define one or more of the selection rules.

Evolving Selection Competition Algorithm Commitment Model Ranking Sub-contractors #1:(1-70%)*(1-80%)*(1-80%)*(1-20%)<1% (false) Sub-contractors #2:(1-70%)*(1-80%)*(1-80%)*(1-20%)<1% (false) Equation 2:

As evident from equation 2, the approximate probability that each of the two expert sub-contractors 104 selected to the subset to fail in providing a high quality outcome for the contracted task is less than 1%. The approximate probability of both expert sub-contractors 104 to fail in providing a high quality outcome is therefore (1-0.99)*(1-0.99) which is less than 0.01% thus ensuring with approximate probability of 99.99% that at least one of the two expert sub-contractor selected to the subset will provide a high quality outcome for the contracted task. There is however, the approximate probability that the outcome of 1 out of 10,000 contracted tasks may fail to be high quality. The selection rule(s) may be optionally adjusted to further reduce the probability for such failure.

The expert sub-contractors 104 who are awarded (instructed) the contracted task may start executing the contracted task according to the requirements outlined in the task description of the contracted task. After completing the contracted task, the expert sub-contractors 104 may deliver the outcome, for example, the report, the analysis, the experiments results and/to the like to the contractor 102 who contracted the contracted task. Delivery of the outcome may be done, for example, from the client terminal 106 used by the expert sub-contractor 104 via the tasks management system 100 to the client terminal 106 used by the contractor 102.

The contractor 102 may further provide feedback on the outcome delivered by one or more of the expert sub-contractors 104 for the contracted task. In particular, the contractor 102 may provide the feedback comprising scores for one or more of the outcome parameters which may be used to compute the compliance score for the respective expert sub-contractor 104.

For example, in case the contractor 102 determines that the quality of the outcome delivered by a certain expert sub-contractor 104 is high, the contractor 102 may assign a high score to the quality outcome parameter. In contrast, in case the contractor 102 determines that the quality of the outcome delivered by a certain expert sub-contractor 104 is low, the contractor 102 may assign a low score to the quality outcome parameter. In another example, in case a certain expert sub-contractor 104 failed to meet one or more of the timing requirements defined for the contracted task in the task description, for example, the deadline, the contractor 102 may assign a low score to the timing compliance outcome parameter. On the other hand, in case a certain expert sub-contractor 104 met all of the timing requirements defined for the contracted task, for example, the expert sub-contractor 104 delivered his outcome to the contracted task before the deadline defined for the task, the contractor 102 may assign a high score to the timing compliance outcome parameter. In another example, the contractor 102 may assign a low score to the timing compliance outcome parameter of a certain expert sub-contractor 104 who failed to meet one or more milestones defined for the task. However, in case the certain expert sub-contractor 104 met all or most of the milestones, the contractor 102 may assign a high score to the timing compliance outcome parameter for the certain expert sub-contractor 104.

Optionally, one or more experts, for example, an independent analyst and/or the like evaluates the outcome delivered by one or more of the expert sub-contractors 104 and assigns the scores according to one or more of the outcome parameters.

The scores assigned to the compliance parameters may be further aggregated to produce an overall compliance score for each of the expert sub-contractors 104 who executed the contracted task. Moreover, the ranking score of one or more of the expert sub-contractors 104 may be computed, adjusted and/or updated according to the compliance score computed for one or more of expert sub-contractors 104 who executed the contracted task.

As such the ranking score and/or the relative ranking of one or more of the plurality of expert sub-contractors 104 may be computed, adjusted and/or updated following each cycle of the process 300 thus enhancing the evolving selection algorithm which may rely on additional information collected for one or more of the expert sub-contractors 104, for example, updated ranking score, updated relative ranking, additional acceptance/decline information, additional information which may be used for more accurately predicting acceptance or decline of one or more future contracted tasks and/or the like.

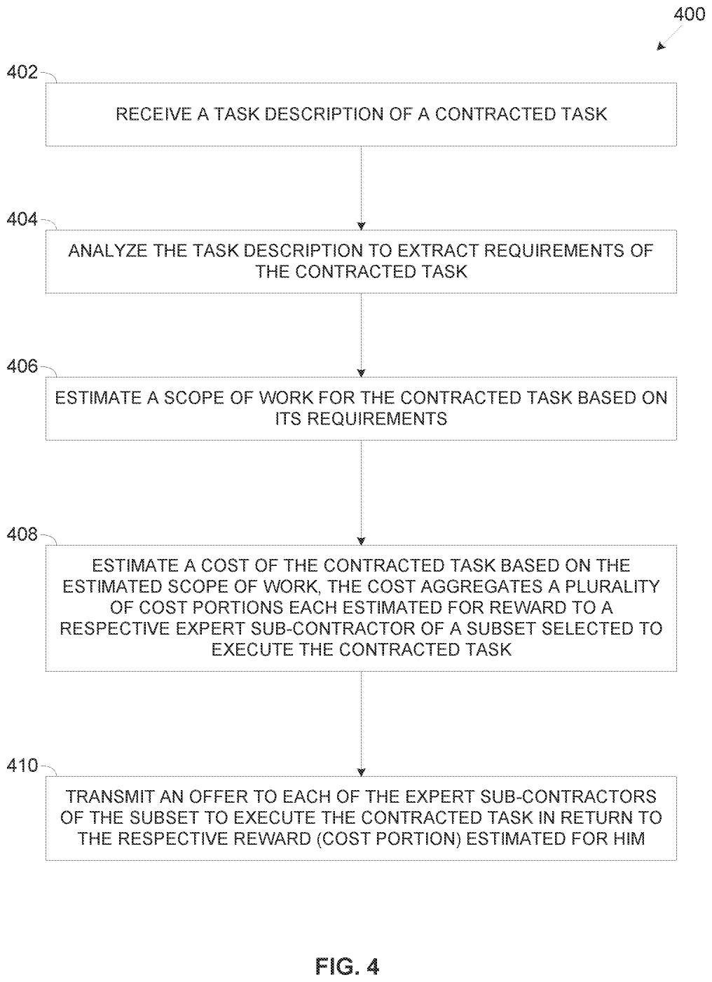

Reference is now made to FIG. 4, which is a flowchart of an exemplary process of automatically estimating a cost of a task contracted by a contractor to a subset selected from a plurality of expert sub-contractors to execute the task, according to some embodiments of the present invention. An exemplary process 400 may be executed by a tasks management system such as the tasks management system 100, specifically by a cost estimator such as the cost estimator 124 to automatically estimate the cost of a task, specifically the cost for rewarding a subset of expert subcontractors such as the expert sub-contractors 104 contracted to execute the task.

It should be noted that the process 400 is described for a single task contracted by a single contractor 102. This however, should not be construed as limiting since the process 400 may be expanded and repeated to estimate the cost of a plurality of contracted tasks.

As shown at 402, the process 400 starts with the cost estimator 124 receiving the task description of the task contracted (outsourced) by the contractor 102 for execution by one or more of the expert sub-contractors 104. For example, the cost estimator 124 may receive the task description created by the task description assistant 120 iteratively with the contractor 102 during the online guided interactive process.

As shown at 404, the cost estimator 124 may analyze the task description to extract the plurality of requirements defined in the task description for the contracted task created as described in the process 200.

As shown at 406, the cost estimator 124 may estimate a scope of work for the contracted task based on the plurality of requirements defined for the contracted task. Since the contracted tasks may typically include analysis and/or evaluation tasks the main cost factor affecting the cost of the contracted task may be the work estimated to be conducted by the selected expert sub-contractors 104. The work conducted by the selected expert sub-contractors 104 may be expressed in one or more metrics, methods and/or techniques.

For example, the scope of work estimated for the contracted task may be expressed by an estimated number of hours required for the expert sub-contractors 104 to execute and complete the contracted task. The scope of work computed by the cost estimator 124 may therefore include an estimated number of hours required for one or more of the expert sub-contractors 104 to execute the contracted task.

The number of hours estimated to be required for the expert sub-contractors 104 to execute the contracted task may vary between different expert sub-contractors 104 according to one or more of their expert attributes, for example, proficiency which may be expressed by their ranking score, experience specifically in the knowledge domain of the contracted task, availability during the time period defined by the requirements for executing the contracted task and/or the like. The cost estimator 124 may therefore compute an aggregated estimated number of hours averaging the number of hours estimated for a plurality of expert sub-contractors 104 to execute the contracted task.

Specifically, the cost estimator 124 may compute the number of hours estimated for each expert sub-contractor 104 of the subset selected to execute the contracted task by a sub-contractor selector such as the sub-contractor selector 122 as described in the process 300.

As shown at 408, the cost estimator 124 may estimate cost of the contracted task based on the estimated scope of work of the contracted task. However, to support the competition model in which the contracted task may be awarded for execution to multiple expert sub-contractors 104, specifically the expert sub-contractors 104 selected to the subset by the sub-contractor selector 122, the cost estimator 124 may estimate a plurality of cost portions each estimated as reward for execution of the contracted task by a respective expert sub-contractors 104 of the subset.

Optionally, the cost estimator 124 may estimate cost of the contracted task based on one or more evaluation models, in particular evolving and learning evaluation model(s) which may evolve over time based on analysis of previously contracted tasks with respect to the one or more aspects of the contractors 102 and/or the expert sub-contractors 104 who were involved and/or engaged in the previously contracted tasks. These aspects may include, for example, the initial budgets allocated by the contractors 102 for the previously contracted tasks, the minimal/maximal budgets allocated by the contractors 102 for the previously contracted tasks, responsiveness of the expert sub-contractors 104 to execute the previously contracted tasks, the commitment level of the expert sub-contractors 104 to execute the previously contracted tasks, the motivation of the expert sub-contractors 104 to execute the previously contracted tasks and/or the like. The cost estimator 124 may therefore apply the learned evaluation model(s) to evaluate the cost of the contracted task to identify an optimal cost of the contracted task which best serves the goals of the contractor 102, the expert sub-contractors 04 and/or the automated tasks management service 100.

For example, the cost estimator 124 may estimate the cost of the contracted task to be a maximal cost that is estimated to be acceptable by the contractor 102 and may allow for maximal compensation (reward, payment) for the expert sub-contractors 104 selected to execute the contracted task as well as to the benefit of the automated tasks management service 100 which may receive a commission computed as a percentage of the cost allocated for the contracted task. In another example, the cost estimator 124 may estimate the cost of the contracted task according to availability of expert sub-contractors 104 determined to be suitable for executing the contracted task. The cost estimator 124 may apply one or more pricing paradigms, for example, supply and demand and/or the like based on the analyzed previously contracted tasks according to one or more. For example, the cost estimator 124 may estimate the cost of the contracted task according to responsiveness of expert sub-contractors 104 to execute previously contracted tasks which are at least partially similar to the (currently) contracted task, for example, in the same knowledge domain, a substantially similar deadline and/or the like. For example, the cost estimator 124 may estimate a lower cost for a contracted task similar to previously contracted tasks to which high responsiveness was recorded from the expert sub-contractors 104. In contrast, the cost estimator 124 may estimate a higher cost for a contracted task similar to previously contracted tasks to which substantially low responsiveness was recorded from the expert sub-contractors 104.

In another example, the cost estimator 124 may determine that the contracted task is very similar to one or more previously contracted tasks executed by multiple expert sub-contractors 104 who may be therefore able to execute the contacted task at significantly low cost since most of the data required for the executing the task may be already available to these expert sub-contractors 104 as well as some or even most of the analysis work. While it may be logical to estimate a low cost for such a contracted task, the cost estimator 124 may not follow this path but rather estimate the cost for the contracted task as if no such similar previous contracted task(s) was executed in the past. The cost estimator 124 may follow this paradigm to allow other expert sub-contractors 104 who did not execute similar previously contracted tasks to participate in the selection process for executing the (currently) contracted task in a fair and non-discriminating manner without the other expert sub-contractors 104 (who did execute similar previously contracted task(s)) having advantage over them.

The cost estimator 124 may compute each of the cost portions (rewards) based on the scope of work estimated for the respective expert sub-contractor 104 of the subset, specifically based on the number of hours estimated for the respective expert sub-contractor 104 to complete the contracted task.

The cost estimator 124 may apply a differential compensation (reward) to compute the cost portions for the plurality of expert sub-contractors 104 of the subset expressing the reward (compensation) to each of the plurality of expert sub-contractors 104 of the subset. For example, the cost estimator 124 may compute each of the cost portions based on the differential compensation according to one or more of the expert attributes of the respective expert sub-contractor 104. For example, the cost estimator 124 may compute an increased cost portion for a high ranking expert sub-contractor 104 compared to the cost portion computed for a lower ranking expert sub-contractor 104.

The cost estimator 124 may then aggregate the plurality of cost portions to produce the overall cost estimated for the contracted task. The estimated cost optionally topped with a commission allocated for the tasks management service provided by the tasks management system 100 may be presented to the contractor 102.

Optionally, the cost estimator 124 adjusts the cost and/or one or more of the cost portions according to availability of expert sub-contractors 104 in the knowledge domain of the contracted task among the plurality of expert sub-contractors 104.The cost estimator 124 may determine the availability of the expert sub-contractors 104 in the knowledge domain according to one or more of, a number of expert sub-contractors identified in the knowledge domain of the contracted task, an expected reward of one or more of the expert sub-contractors 104 of the subset selected for executing the contracted task, a geographical area targeted by the contracted task, a scheduling attribute affecting one or more of the expert sub-contractors 104 of the subset with respect to one or more timing requirements defined for the contracted task.

For example, the cost estimator 124 may increase the cost in case there are very few expert sub-contractors 104 identified as experts in the knowledge domain of the contracted task. In contracts, the cost estimator 124 may reduce the cost in case expert sub-contractors 104 identified as experts in the knowledge domain of the contracted task are available in abundant.

In another example, the cost estimator 124 may increase the cost in case very few expert sub-contractors 104 are available to execute the contracted task in the geographical area targeted by the contracted task while the cost estimator 124 may reduce the cost in case many expert sub-contractors 104 are available to execute the contracted task in the target geographical area.

In another example, the cost estimator 124 may increase the cost in case very few expert sub-contractors 104 are available to execute the contracted task due to one or more scheduling attributes preventing one or more of the expert sub-contractors 104 from meeting the timing requirement(s). Such scheduling attributes may include, for example, an upcoming holiday, an upcoming vacation, other engagement and/or the like which may limit the available working time of the respective expert sub-contractor 104. On the other hand, the cost estimator 124 may reduce the cost in case many expert sub-contractors 104 are available to execute the contracted task based on the scheduling attribute(s), for example, spare time available to a plurality of the expert sub-contractors 104 and/or the like.

Optionally, the cost estimator 124 adjusts the cost and/or one or more of the cost portions according to availability of unlisted expert sub-contractors which are not listed in the pool of the plurality of expert sub-contractors 104, i.e. the unlisted expert sub-contractors are not listed among the plurality of expert sub-contractors 104. For example, the cost estimator 124 may reduce the cost in case it identifies multiple unlisted expert sub-contractors who may be selected to the subset for executing the contracted task. However, the cost estimator 124 may increase the cost in case it identifies no or very few unlisted expert sub-contractors who may be suitable for executing the contracted task.

Optionally, the cost estimator 124 adjusts the cost and/or one or more of the cost portions according to the cost estimated for one or more previous contracted tasks having at least partially similar scope of work as the contracted task. For example, assuming several previous contracted tasks were estimated to require a certain number of hours for their execution which is substantially similar to the number of hours estimated for execution of the currently contracted task. In such case, the cost estimator 124 may adjust the estimated cost according to the cost estimated for one or more of the substantially similar previous contracted tasks. Moreover, the cost estimator 124 may adjust the estimated cost according to an aggregation (e.g. average) of the costs estimated for a plurality of the substantially similar previous contracted tasks. Furthermore, assuming the actual number of hours that was required for the expert sub-contractors 104 to execute one or more of the substantially similar previous contracted tasks exceeded the estimated number of hours, for example, by an average of 15%. In such case the cost estimator 124 may further adjust the estimated cost according to the deviation of the actual scope of work from the estimated scope of work, i.e. increase the cost by 15%.

As shown at 410, the cost estimator 124 may offer each of the expert sub-contractors 104 selected in the subset to execute the contracted task in return to the respective cost portion computed (estimated) for the respective expert sub-contractor 104. For example, the cost estimator 124 may initiate transmission and/or transmit the value of each cost portion to each client terminal 106 associated with and used by each respective expert sub-contractor 104.

Optionally, the cost estimator 124 may adjust the cost and/or one or more of the cost portions according to a responsiveness of one or more of the expert sub-contractors 104 of the subset to execute the contracted task in return for a respective portion (reward) of the estimated total cost. The cost estimator 124 may determine the responsiveness of one or more of the expert sub-contractors 104 according to their acceptance to execute the contracted task based on the offer they received from the cost estimator 124. For example, the cost estimator 124 may determine the responsiveness of one or more of the expert sub-contractors 104 according to the number of expert sub-contractors 104 who are willing to commit to execute the contracted task by paying the commitment fee as described in detail herein after.

For example, assuming none of the expert sub-contractors 104 of the subset selected to execute the contracted task commits to execute the contracted task, the cost estimator 124 may determine that the cost portions estimated for reward to the expert sub-contractors 104 are too low and may increase them accordingly in attempt to convince at least some of the expert sub-contractors 104 to commit to execute the contracted task. In another example, the cost estimator 124 may wait for the commitments from the expert sub-contractors 104 of the subset for a certain predefined time period. In case an insufficient number of the expert sub-contractors 104 commits to execute the contracted task, the cost estimator 124 may increase one or more of the cost portions in attempt to convince the respective expert sub-contractors 104 to commit to execute the contracted task. In another example, in case all expert sub-contractors 104 of the subset commit to execute the contracted task in very short time period (e.g. 2 hours), the cost estimator 124 may determine that the cost portions estimated for reward to the expert sub-contractors 104 are too high and may reduce the cost accordingly to the benefit of the contractor 102.

The cost estimator 124 may further adjust the cost and/or one or more of the cost portions according to the responsiveness of one or more of the expert sub-contractors 104 of the subset to execute one or more previous contracted tasks that were offered to them for execution. In particular, the cost estimator 124 may adjust the cost portion estimated for reward to one or more of the expert sub-contractors 104 according to the responsiveness of the expert sub-contractor(s) 104 to execute one or more of the previous contracted tasks in return for a certain reward (cost portion). For example, assuming that based on past experience relating to offers made to a certain one of the expert sub-contractors 104 in the past, the certain expert sub-contractor 104 declined a first reward offer and accepted a second reward offer higher than the first reward offer. In such case the cost estimator 124 may adjust the cost portion estimated for reward to the certain expert sub-contractor 104 to be in a range between the first reward offer and the second reward offer.

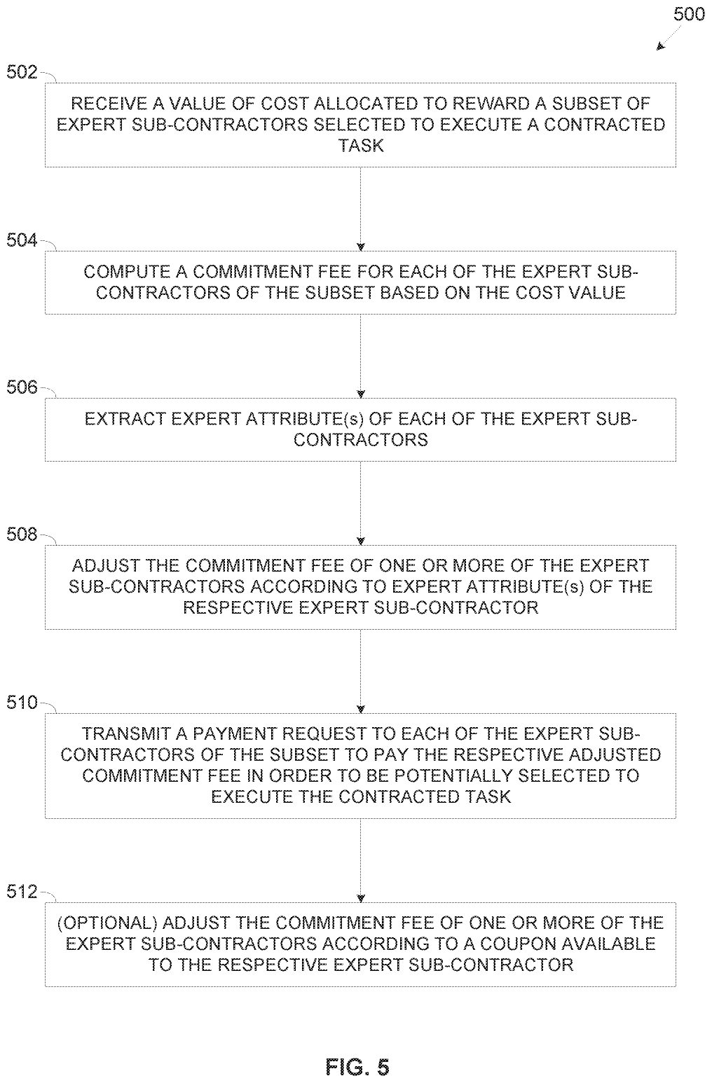

Reference is now made to FIG. 5, which is a flowchart of an exemplary process of automatically computing a commitment fee for each of a plurality of expert sub-contractors of a subset selected from a plurality of expert sub-contractors to execute a contracted task, according to some embodiments of the present invention. An exemplary process 500 may be executed by a tasks management system such as the tasks management system 100, specifically by a commitment fee calculator such as the commitment fee calculator 126 to automatically compute a commitment fee each expert sub-contractor such the expert sub-contractor 104 selected to execute a contracted task is required to pay in order to express his commitment and be considered to be awarded (given) the contracted task.

The commitment fee calculator 126 may compute the commitment fee for a plurality of expert sub-contractors 104 selected as candidates to execute the contracted task, i.e. the subset of expert sub-contractors 104. These candidate expert sub-contractors 104 may need to express their willingness to pay the commitment fee computed for them in order to be further considered as valid candidates for executing the contracted task.

However, only the expert sub-contractors 104 who are eventually selected to actually execute the contracted task are required to actually pay the commitment fee computed for them.

It should be noted that the process 500 is described for a single task contracted by a single contractor 102. This however, should not be construed as limiting since the process 500 may be expanded and repeated to compute the commitment fees for a plurality of subsets of expert sub-contractors 104 selected to execute a plurality of contracted tasks.

As shown at 502, the process 500 starts with the commitment fee calculator 126 receiving a value of cost allocated to reward (compensate) the plurality of expert sub-contractors 104 of the subset selected to execute the contracted task. For example, the commitment fee calculator 126 may receive the cost value from the cost estimator 124.

As shown at 504, the commitment fee calculator 126 may compute a commitment fee for each of the expert sub-contractors 104 of the subset. For example, the commitment fee calculator 126 may compute an equal commitment fee for each of the selected sub-contractors 104, for example, 5% of the cost value.

As shown at 506, the commitment fee calculator 126 may extract one or more expert attributes of each of the selected expert sub-contractors 104, for example, his ranking score, one or more of his professional attributes and/or the like.

As shown at 508, the commitment fee calculator 126 may adjust the commitment fee computed for one or more of the selected expert sub-contractors 104 according to one or more of the expert attributes identified for the respective expert sub-contractor 104. For example, the commitment fee calculator 126 may reduce the commitment fee computed for a first expert sub-contractor 104 having a high ranking score indicative of successful execution of multiple previous contracted tasks which may be further indicative of a high commitment level of the first expert sub-contractor 104 and hence of high confidence in the first expert sub-contractor 104 to successfully complete the contacted task thus requiring a reduced commitment fee. In contrast, the commitment fee calculator 126 may increase the commitment fee computed for a second expert sub-contractor 104 identified to have failed to deliver his outcome to one or more previous contracted tasks which may be indicative of a low commitment level and hence of lower confidence in the second expert sub-contractor 104 to successfully complete the contacted task thus requiring an increased commitment fee to ensure his commitment. In another example, the commitment fee calculator 126 may reduce the commitment fee computed for one or more of the selected expert sub-contractor 104 in case there are very few experts in the knowledge domain of the contracted task since the limited availability may put the selected expert sub-contractor 104 in an advantageous position to negotiate for reduced commitment fees. In contrast, the commitment fee calculator 126 may increase the commitment fee computed for one or more of the selected expert sub-contractor 104 in case there are many experts in the knowledge domain of the contracted task since in case of refusal of one selected expert sub-contractor 104, another expert sub-contractor 104 may be selected to execute the contracted task.

Optionally, the commitment fee calculator 126 adjusts the commitment fee computed for one or more of the expert sub-contractors 104 of the subset according to the success score computed for the respective expert sub-contractor, for example, by the sub-contractor selector 122, specifically by the evolving selection algorithm as described in the process 300. For example, the commitment fee calculator 126 may reduce the commitment fee computed for a first expert sub-contractor 104 having a high success score since the high success score may reflect increased confidence in the ability and hence the commitment of the first expert sub-contractor 104 to execute the contracted task. On the other hand, the commitment fee calculator 126 may increase the commitment fee computed for a second expert sub-contractor 104 having a low success score since the low success score may reduce confidence in the ability of the second expert sub-contractor 104 to successfully execute the contracted task to and hence may reflect reduced commitment level of the second expert sub-contractor 104.

Optionally, the commitment fee calculator 126 adjusts the success score used to adjust the commitment fee for one or more of the expert sub-contractors 104 of the subset according to weights assigned to each of a plurality of professional attributes of the respective expert sub-contractor 104. For example, a large weight may be assigned to the knowledge domain of the contracted task. The commitment fee calculator 126 may therefore increase, according to the large weight, the success score of a first expert sub-contractor 104 whose main knowledge domain fully overlaps with the knowledge domain of the contracted task. However, the commitment fee calculator 126 may reduce, according to the large weight, the success score of a second expert sub-contractor 104 whose main knowledge domain overlaps only partially with the knowledge domain of the contracted task. As such the commitment fee adjusted, based on the adjusted success score, for the first expert sub-contractor 104 may be reduced since, the contracted task being in his main knowledge domain, it is highly probable with high confidence that he will successfully execute the contracted task. The commitment fee adjusted, based on the adjusted success score, for the second expert sub-contractor 104 may be increased since, the contracted task not being in his main knowledge domain, it may be less probable that he will successfully execute the contracted task.

Optionally, the commitment fee calculator 126 adjusts the commitment fee computed for one or more of the expert sub-contractors 104 of the subset according to an enhancement score computed for the respective expert sub-contractor 104 of the subset, for example, by the sub-contractor selector 122, specifically by the evolving selection algorithm as described in the process 300. For example, a first expert sub-contractor 104 may have a significantly high enhancement score indicating that evolving selection algorithm may significantly enhance as result of execution of the contracted task by the first expert sub-contractor 104. Since this major enhancement is highly beneficial, in order to encourage and motivate the first expert sub-contractor 104 to commit and execute the contracted task, the commitment fee calculator 126 may reduce his commitment fee.

Optionally, the commitment fee calculator 126 adjusts the commitment fee computed for one or more of the expert sub-contractors 104 of the subset according to a recruitment channel used to recruit the respective expert sub-contractor 104. The recruitment channel may include, for example, a recommendation received from one or more other expert sub-contractors 104, a recommendation received from one or more of the contractors 102, tracking members of groups of expert sub-contractors such as the expert sub-contractors 104, a recruitment publication, a recruitment automated service and/or the like. For example, expert sub-contractors 104 recruited based on recommendation from other expert sub-contractors 104 and/or contractors 102 may be considered more reliable compared to expert sub-contractors 104 recruited through public means, such as the recruitment publications and/or the recruitment service(s). Therefore, the commitment fee calculator 126 may reduce the commitment fee computed for a first expert sub-contractor 104 recruited based on recommendation compared to the commitment fee computed for a second expert sub-contractor 104 recruited based on public means.

As shown at 510, the commitment fee calculator 126 may output the value of the commitment fee required from each of the expert sub-contractors 104 selected in the subset in order to be entitled to execute the contracted task. For example, the commitment fee calculator 126 may initiate transmission and/or transmit each value of the commitment fee to each client terminal 106 associated with and used by each respective expert sub-contractor 104. As described herein before, in case one or more of the expert sub-contractors 104 fails or declines to pay the commitment fee required of him, the respective expert sub-contractor 104 may be excluded from the subset and may not be awarded execution of the contracted task.

Optionally, as shown at 512, the commitment fee calculator 126 may adjust the commitment fee computed for one or more of the expert sub-contractors 104 of the subset according to one or more coupons presented by the respective expert sub-contractor 104.

The respective expert sub-contractor 104 may present his coupon(s) before receiving the value of the commitment fee he is required to pay, for example, after selected to the subset. However, the respective expert sub-contractor 104 may present his coupon(s) after receiving the value of the commitment fee computed by the commitment fee calculator 126 thus initiating another cycle for the commitment fee calculator 126 to adjust the commitment fee for the respective expert sub-contractor 104 according to the presented coupon(s).

The coupons which may be issued occasionally, periodically and/or on demand by the tasks management system 100, may entitle their holder to receive a discount in the commitment fee he may be required to pay in order to be considered as candidate for execution of one or more contracted tasks. The coupons may be issued to one or more of the expert sub-contractors 104 according to one or more criteria, for example, seniority (time registered in tasks management system 100), productivity (number of executed contracted tasks), influence on other expert sub-contractors 104 and/or the like. The expert sub-contractors 104 who received one or more coupons may further distribute them to one or more other expert sub-contractors 104.

Therefore, in case the commitment fee calculator 126 determines that one or more expert sub-contractors 104 of the subset hold one or more valid coupons, the commitment fee calculator 126 may adjust, specifically reduce the commitment fee computed for the respective expert sub-contractor(s) 104 according to the value indicated by the coupon(s).

As described herein before, several of the individual embodiments of the tasks management system 200, for example, the task description assistance 120, the sub-contractor selector 122, the cost estimator 124 and/or the commitment fee calculator 126 which may be interdependent and/or interlinked with each other may be combined together to form a comprehensive constantly evolving tasks management service. For example, as described herein before, the sub-contractor selector 122 may select one or more of the expert sub-contractors 104 according to their responsiveness and willingness to pay the commitment fee. In another example, cost estimator 124 may adjust the cost estimated for the contracted task according to the selected expert sub-contractors and/or according to their responsiveness and willingness to pay the commitment fee. In another example, the commitment fee calculator 126 may adjust the commitment fee computed for one or more of the candidate expert sub-contractors 104 selected by the sub-contractor selector 122 according to their expert attribute(s). In yet another example, the commitment fee calculator 126 may adjust the commitment fee computed for one or more of the candidate expert sub-contractors 104 according to cost estimated for the contracted task by the cost estimator 124.

For example, the sub-contractor selector 122 may select a subset of 20-30 expert sub-contractors 104 as candidates for executing a certain contracted task. The commitment fee calculator 126 may compute and adjust a commitment fee for each of the candidate expert sub-contractors 104 of the subset and send each of them the respective commitment fee they may be required to pay in case they are selected to actually execute the contracted task. Assuming that six out of the 20-30 candidate expert sub-contractors 104 agree to commit and pay their respective commitment fee in case they are selected to execute the task, the sub-contractor selector 122 may select two expert sub-contractors 104 out of the six expert sub-contractors 104 who agreed to commit to execute the contacted task. The sub-contractor selector 122 may then notify these two expert sub-contractors 104 to pay the commitment fee and start executing the contacted task. While the sub-contractor selector 122 may issue an explicit request to the two expert sub-contractors 104 to pay the commitment fee, such notification may be redundant since by expressing they already expressed their agreement to commit and pay the commitment fee. In such case, the sub-contractor selector 122 may simply charge the payment of the commitment fee from the two expert sub-contractors 104 and instruct them to start executing the contacted task.

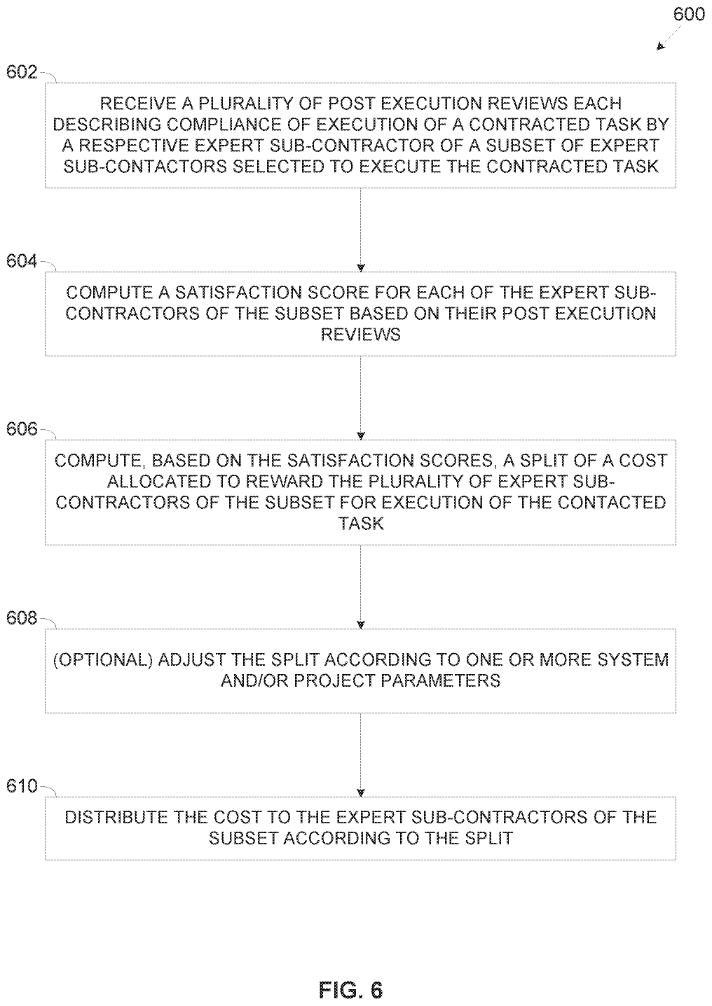

Reference is now made to FIG. 6, which is a flowchart of an exemplary process of automatically distributing cost allocated for reward to a plurality of expert sub-contractors who each independently executed a contracted task, according to some embodiments of the present invention. An exemplary process 600 may be executed by a tasks management system such as the tasks management system 100, specifically by a reward distributer such as the reward distributer 128 to automatically compute a split of a cost allocated for reward to a subset of expert sub-contractors such the expert sub-contractors 104 selected to execute a contracted task.

It should be noted that the process 600 is described for a single task contracted by a single contractor such as the contractor 102. This however, should not be construed as limiting since the process 600 may be expanded and repeated to compute the reward split (distribution) for the expert sub-contractors 104 for a plurality of contracted tasks.

As shown at 602, the process 600 starts with the reward distributer 128 a plurality of post execution reviews. Each of the plurality of post execution reviews is generated to describe the quality a respective outcome received from a respective one of the plurality of expert sub-contractors 104 of the subset who executed the contracted task independently from the other expert sub-contractors 104 of the subset.

In particular, each post execution review may express the satisfaction level from the respective outcome which may be quantified by computing the compliance score according to one or more of the compliance parameters, for example, quality, timing, responsiveness and/or the like.

For example, the post execution review may rate and/or rank the satisfaction level by assigning a compliance score for the quality of the respective outcome for example, professionalism, expertise, thoroughness, accuracy and/or the like of the analysis, research, insights, conclusions, recommendations and/or the like included in the respective outcome with respect to the analysis question(s) outlined in the requirements of the contracted task. For example, a first expert sub-contractor 104 who generated a high quality outcome for the contracted task may be assigned a high compliance score for the quality compliance parameter. In contrast, a second expert sub-contractor 104 who generated a lower quality outcome for the contracted task may be assigned a lower compliance score for the quality compliance parameter.

In another example, the post execution review may rate and/or rank the satisfaction level by assigning a compliance score for compliance of the respective expert sub-contractor 104 with the timing requirements defined for the contracted task. For example, a first expert sub-contractor 104 who provided his outcome for the contracted task within the deadline timing requirement defined for the contracted task may be assigned a high compliance score for the timing compliance parameter. In contrast, a second expert sub-contractor 104 who was late to provide his outcome for the contracted task by, for example, one week with respect to the deadline defined for the contracted task may be assigned a lower compliance score for the timing compliance parameter.

In another example, the post execution review may rate and/or rank the satisfaction level by assigning a score to the responsiveness of the respective expert sub-contractor 104 to, for example, inquiries and/or interaction with the contractor 102.

The compliance scores assigned for one or more of the compliance parameters may be further aggregated, for example, summed, averaged and/or the like to compute an aggregated (overall) compliance score for the respective outcome generated by the respective expert sub-contractor 104 of the selected subset. For example, a first expert sub-contractor 104 who was highly accessible and responded rapidly to communication from the contractor 102 may be assigned a high compliance score for the responsiveness compliance parameter. In contrast, a second expert sub-contractor 104 who failed to provide timely responses to communication from the contractor 102 may be assigned a lower compliance score for the responsiveness compliance parameter.

One or more of the plurality of post execution reviews may be created by the contractor 102 of the contracted task after completion of execution of the contracted task by the respective expert sub-contractor 104. The contractor 102 may create each post execution review to include ranking of his satisfaction level with respect to the respective outcome and/or the process of the respective expert sub-contractor 104 to generate the respective outcome based on compliance with the requirements defined for the contracted task as described herein before.

Optionally, one or more of the post execution reviews may be created by one or more professionals, for example, an expert sub-contractor such as the expert sub-contractor 104, a person professional in the knowledge domain of the contracted task, an academic person who is regarded as an authority in the knowledge domain of the contracted task and/or the like.

As shown at 604, the reward distributer 128 may compute a satisfaction score for each of the expert sub-contractors 104 who executed the contracted task. The reward distributer 128 may compute the satisfaction score for each expert sub-contractor 104 based on analysis of the respective post execution review created for the respective expert sub-contractor 104, specifically with respect to one or more of the compliance parameters. For example, the reward distributer 128 may compute the satisfaction score based on the compliance score computed for the respective expert sub-contractor 104 with respect to one or more of the compliance parameters.

As shown at 606, the reward distributer 128 may compute a split of the cost of the contracted task based on the satisfaction score computed for each of the expert sub-contractors 104 who executed the contracted task. In particular, the reward distributer 128 may compute the split of the cost allocated for reward to the subset of the expert sub-contractors 104 who executed the contracted task after selected as described in the process 300. For example, assuming the subset included two expert sub-contractors 104, the reward distributer 128 may compute the split of the cost to two portions where each portion is the reward to one of the two expert sub-contractors 104. In another example, assuming the subset included three expert sub-contractors 104, the reward distributer 128 may compute the split of the cost to three portions where each portion is the reward to one of the two expert sub-contractors 104.

The reward distributer 128 may compute the split based on a proportion between the satisfaction scores computed for the expert sub-contractors 104 such the portions computed for reward to each of the expert sub-contractors 104 may be proportional to their satisfaction scores. For example, assuming two expert sub-contractors 104 executed the contracted task where the first expert sub-contractor 104 has a satisfaction score of 0.85 (out of 1) and the second expert sub-contractor 104 has a satisfaction score of 0.7. In such case the reward distributer 128 may compute the split of the reward cost to the first and second expert sub-contractors 104 according to the proportion of their satisfaction scores such that the portion of the first expert sub-contractor 104 is 65% of the cost allocated as reward for execution of the contracted task while the portion of the second expert sub-contractor 104 is 35% of the allocated cost.

As shown at 608, the reward distributer 128 may optionally adjust the split according to one or more system and/or project parameters.

For example, the reward distributer 128 may adjust the split according to the success score computed for each of the expert sub-contractors 104 before the execution of the contracted task as described in the process 300 and an actual success level of the respective expert sub-contractor 104 computed based on the compliance score computed for the respective expert sub-contractor 104 after completion of the execution of the contracted task. This may be done in order to establish a more personal baseline for rewarding one or more of the expert sub-contractors 104 and reduce dependency on the performance of the other expert sub-contractors 104 of the subset who may be significantly more experienced, higher ranked and/or the like. This may be of particular interest for fairly rewarding (compensating) and thus maintaining motivation of expert sub-contractors 104 who were selected based on their high enhancement score to the benefit of enhancing the evolving selection algorithm while predicted to succeed less than the other expert sub-contractors 104 of the subset who were selected based on their high success score.

For example, assuming a success score of 0.9 (out of 1) was computed for a first expert sub-contractor 104 of a subset of two expert sub-contractors 104 during the process 300 while a success score of 0.7 was computed for the second expert sub-contractor 104. Further assuming the satisfaction score computed for the first expert sub-contractor 104 after the execution of the contracted task is 0.85 and the satisfaction score computed for the second expert sub-contractor 104 is 0.7. In such case instead of computing a 65%-35% split as described herein before, the reward distributer 128 may adjust the split according to a match between the predicted and actual success scores such. Specifically, the match for the first expert sub-contractor 104 may be 0.85/0.9=0.9444 while the match for the second expert sub-contractor 104 may be 0.7/0.7=1/0. In such case the reward distributer 128 may adjust the split in favor of the second expert sub-contractor 104 who was able to stand up to the expectation, for example, a 55%-45% split.

In another example, the reward distributer 128 adjusts the split according to the one or more previous contracted tasks executed by one or more of the expert sub-contractors 104 of the subset who executed the contracted task. This may be done to reward (compensate) one or more of the expert sub-contractors 104 according to a reference and a trend of tasks previously executed in the past by the respective expert sub-contractor 104. For example, assuming a first expert sub-contractor 104 executed two previous tasks and had a satisfaction score of 0.65 in the earlier one of the previous tasks and a satisfaction score of 0.7 in the later earlier one of the previous tasks. In such case, assuming a satisfaction score of 0.75 is computed for the first expert sub-contractor 104 for the (current) contracted task, the reward distributer 128 may adjust the split in favor of the first expert sub-contractor 104 demonstrating constant improvement. In another example, assuming a second expert sub-contractor 104 executed two previous tasks and had a satisfaction score of 0.9 in the earlier one of the previous tasks and a satisfaction score of 0.8 in the later earlier one of the previous tasks. In such case, assuming a satisfaction score of 0.75 is computed for the second expert sub-contractor 104 for the (current) contracted task, the reward distributer 128 may adjust the split against the second sub-contractor 104 demonstrating constant regression.

In another example, the reward distributer 128 adjusts the split according to the one or more expert attributes of one or more of the expert sub-contractors 104 of the subset who executed the contracted task. For example, assuming a first expert sub-contractor 104 of the subset has major seniority, for example, 20 years of activity in the knowledge domain of the contracted task while a second expert sub-contractor 104 of the subset is a relative junior having significantly less experience, for example, 3 years. In such case, the reward distributer 128 may adjust the split in favor of the first expert sub-contractor 104 having seniority over the second expert sub-contractor 104. In another example, assuming a first expert sub-contractor 104 of the subset is ranked higher than a second expert sub-contractor 104 of the subset, i.e. has a higher ranking score. In such case, the reward distributer 128 may adjust the split in favor of the first expert sub-contractor 104 who is ranked higher than the second expert sub-contractor 104.

In another example, the reward distributer 128 adjusts the split according to a non-linear distribution function applied to reduce a degree of the proportion used to split the cost portions between the pluralities of expert sub-contractors 104 of the subset thus reducing differentiation between the cost portions. The non-linear distribution may be applied to have a more common (averaged) distribution to avoid major differences between the cost portions distributed to the different expert sub-contractors 104 of the subset in order to reduce and desirably avoid discontent and disappointment of expert sub-contractors 104 receiving significantly low cost portions compared to other expert sub-contractors 104.

Moreover, the reward distributer 128 may adjust and/or update the non-linear distribution function according to one or more operational parameters and/or behavioral characteristics and patterns of the contractors 102 and/or the expert sub-contractors 104, for example, a satisfaction level of the contractors 102, a content level of the expert sub-contractors 104, willingness of the expert sub-contractors 104 to accept contracted tasks and/or the like. The reward distributer 128 may further apply one or more ML models and optionally reinforced ML models to identify these behavioral patterns and adjust the non-linear distribution function to conform with the identified behavioral patterns and/or to shift these behavioral patterns as desired.

In another example, the reward distributer 128 adjusts the split according to an evaluation conducted by one or more professionals, for example, a system administrator, a system operator and/or the like authorized to alter and/or intervene with operation of the tasks management system 100, to manually adjust the split of the reward cost between the expert sub-contractors 104 of the subset.

As shown at 610, the reward distributer 128 may distribute or instruct distribution of the cost portions to each of the expert sub-contractors 104 selected in the subset to execute the contracted task. For example, the reward distributer 128 may transmit a funds transfer instruction to one or more monetary systems, for example, a banking system, a credit system, a payment service and/or the like to transfer each cost portion to the respective one of the expert sub-contractors 104.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms ML models and reinforced learning are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of selecting automatically expert sub-contractors most relevant for executing tasks, comprising:
analyzing a task description defined for a contracted task to extract a plurality of requirements of the contracted task;
applying an evolving selection algorithm to compute at least a success score and an enhancement score for each of at least some of a plurality of expert sub-contractors evaluated for executing the contracted task, the success score indicating an estimated probability of the respective expert sub-contractor to successfully execute the contracted task according to the plurality of requirements and the enhancement score indicating an estimated enhancement of the evolving selection algorithm by execution of the contracted task by the respective expert sub-contractor;
selecting automatically a subset from the at least some expert sub-contractors based on the computed success and enhancement scores according to at least one selection rule such that the subset comprising at least one expert sub-contractor having a success score exceeding a first threshold and at least another one expert sub-contractor having an enhancement score exceeding a second threshold; and
instructing each expert sub-contractor of the subset to execute the contracted task.

2. The computer implemented method of claim 1, wherein the plurality of requirements comprising at least some of: a knowledge domain of the contracted task, a field of the contracted task, a title of the contracted task, a market segment targeted by the contracted task, a scope of work of the contracted task, a geographical area targeted by the contracted task, a timing requirement of the contracted task, and at least one preferred expert sub-contractor identified by a contractor of the contracted task.

3. The computer implemented method of claim 1, wherein the evolving selection algorithm is configured to compute the success score of each of the at least some expert sub-contractors according to at least one expert attribute of the respective expert sub-contractor, the at least one expert attribute is a member of a group consisting of: a ranking score of the respective expert sub-contractor and at least one professional attribute of the respective expert sub-contractor.

4. The computer implemented method of claim 3, wherein the ranking score is computed for the respective expert sub-contractor based on a compliance score computed for an outcome of at least one previous contracted task executed by the respective expert sub-contractor, the compliance score is computed based on at least one outcome parameter of the outcome, the at least one outcome parameter is a member of a group consisting of: quality of the outcome, compliance of the outcome with at least one timing requirement of the plurality of requirement, and responsiveness of the respective expert sub-contractor during the execution of the contracted task.

5. The computer implemented method of claim 4, wherein the at least one outcome parameter is extracted from at least one of: a feedback received from a contractor of the respective contracted task for the outcome received from the respective expert sub-contractor, a professional review conducted for the outcome received from the respective expert sub-contractor, and an automatic analysis of the outcome received from the respective expert sub-contractor.

6. The computer implemented method of claim 4, wherein the compliance score computed for each of the expert sub-contractors of the subset based on the outcome of the contracted task executed by the respective expert sub-contractor is used by the evolving selection algorithm to adjust the ranking score of the respective expert sub-contractor.

7. The computer implemented method of claim 4, wherein the evolving selection algorithm is further configured to adjust the ranking score of at least one expert sub-contractor of the subset with respect to the ranking score of at least another one of the plurality of expert sub-contractors according to at least one ranking parameter, the at least one ranking parameter is a member of a group consisting of: a number of previous contracted tasks executed by at least one of the plurality of expert sub-contractors in a knowledge domain of the contracted task, an aggregated compliance score computed for at least one of the plurality of expert sub-contractors based on his execution of a plurality of previous contracted tasks in a knowledge domain of the contracted task, and a number of expert sub-contractors available in the knowledge domain of the contracted task.

8. The computer implemented method of claim 3, wherein the at least one professional attribute is a member of a group consisting of: age, gender, a knowledge domain, experience, language, geographical location, expected reward for executing the contracted task, availability, and an influence evaluated for the respective expert sub-contractor on at least another one of the plurality of expert sub-contractors.

9. The computer implemented method of claim 8, further comprising the at least one professional attribute of the respective expert sub-contractor is extracted from at least one online resource comprising at least one of: a private online resource and a public online resource.

10. The computer implemented method of claim 8, wherein the evolving selection algorithm is further configured to adjust the success score computed for the respective expert sub-contractor according to a respective weight assigned to each of a plurality of professional attributes of the respective expert sub-contractor.

11. The computer implemented method of claim 1, wherein the evolving selection algorithm is configured to compute the enhancement score for each of the at least some expert sub-contractors based on at least one past engagement parameter identified for the respective expert sub-contractor, the at least one past engagement parameter is a member of a group consisting of: a number of offers submitted to the respective expert sub-contractor for executing previous contracted tasks, a number of offers accepted by the respective expert sub-contractor for executing previous contracted tasks, a number of previous contracted tasks submitted to the respective expert sub-contractor for execution, a reward range of previous contracted tasks accepted or declined by the respective expert sub-contractor, a trend of the reward range accepted or declined by the respective expert sub-contractor, and a knowledge domain of previous contracted tasks accepted or declined by the respective expert sub-contractor;
wherein the evolving selection algorithm is further configured to compute the enhancement score for at least one of the plurality of expert sub-contractors based on estimated source cause of the at least one past engagement parameter identified for the at least one expert sub-contractor, the estimated source cause is a member of a group consisting of: type of the knowledge domain of at least one of the previous contracted tasks, a value of the reward offered for executing at least one of the previous contracted tasks, availability or unavailability due to personal reasons, availability or unavailability due to cultural reasons and confidence of the at least one expert sub-contractor in the selection process.

12. The computer implemented method of claim 1, wherein the evolving selection algorithm is further configured to compute the enhancement score for at least one of the plurality of expert sub-contractors based on an estimated future demand for executing a plurality of future contracted tasks, the future demand is estimated based on a at least one of: a knowledge domain trend identified for previous contracted tasks, a reward range trend identified for previous contracted tasks, geographical areas targeted by previous contracted tasks, and market segments targeted by previous contracted tasks.

13. The computer implemented method of claim 1, wherein the evolving selection algorithm is at least one of:
utilized by at least one trained machine learning model trained with a plurality of training tasks evaluated for execution by the plurality of expert sub-contractors coupled with respective outcomes of execution of each of the plurality of training tasks by at least one of the plurality of expert sub-contractors,
further configured to select to the subset at least one unlisted expert sub-contractor identified in at least one online resource, the selection is based on a match between at least one professional attribute identified for the at least one unlisted expert sub-contractor and at least some of the plurality of requirements,
select to the subset at least one unlisted expert sub-contractor recommended by at least one of the plurality expert sub-contractors,
select to the subset at least one expert sub-contractor from at least one another knowledge domain different from the knowledge domain of the contracted task, the selection is based on at least partial match between at least one professional attribute identified for the at least one expert sub-contractor and the plurality of requirements.

14. The computer implemented method of claim 1, wherein the task description is fabricated by a contractor of the task; further comprising adjusting a User Interface (UI) of a client device used by the contractor to fabricate the task description to follow an online guided interactive process comprising presenting to the contractor a plurality of guiding questions and receiving from the contractor information in response to the plurality of guiding questions.

15. The computer implemented method of claim 1, wherein the first threshold is defined to ensure a minimal success probability of at least one expert sub-contractor of the subset to successfully execute the contracted task by complying with the plurality of requirements.

16. The computer implemented method of claim 1, wherein the second threshold is defined to ensure a minimal probability of the evolving selection algorithm to enhance based on an outcome of the execution of the contracted task by at least one of the expert sub-contractor of the subset, the enhancement comprises at least one of: computing an initial success score and/or an initial enhancement score for at least one new expert sub-contractor, adjusting the success score and/or the enhancement score of at least one of the plurality of expert sub-contractors, and enhancing at least one grouping algorithm used by the evolving selection algorithm to select at least some expert sub-contractors as candidates for executing at least one future contracted task.

17. A system for selecting automatically expert sub-contractors most relevant for executing tasks, comprising:
at least one processor configured for executing a code, the code comprising:
code instructions to analyze a task description defined for a contracted task to extract a plurality of requirements of the contracted task;
code instructions to apply an evolving selection algorithm to compute at least a success score and an enhancement score for each of at least some of a plurality of expert sub-contractors evaluated for executing the contracted task, the success score indicating an estimated probability of the respective expert sub-contractor to successfully execute the contracted task according to the plurality of requirements and the enhancement score indicating an estimated enhancement of the evolving selection algorithm by execution of the contracted task by the respective expert sub-contractor;
code instructions to select automatically a subset from the at least some expert sub-contractors based on the success and enhancement scores according to at least one selection rule such that the subset comprising at least one expert sub-contractor having a success score exceeding a first threshold and at least another one expert sub-contractor having an enhancement score exceeding a second threshold; and
code instructions to instruct each expert sub-contractor of the subset to execute the contracted task.

18. A computer implemented method of estimating automatically cost of tasks contracted to expert sub-contractors, comprising:
extracting a plurality of requirements from a task description defined for a contracted task;
estimating a scope of work of the contracted task based on analysis of the plurality of requirements;
estimating, based on the estimated scope of work, a cost of the contracted task, the cost is an aggregation of a plurality of cost portions each estimated for reward for execution of the contracted task by a respective one of a subset of expert sub-contractors selected from a plurality of expert sub-contractors; and
initiating a transmission of an offer to each of the sub-contractors of the subset to execute the contracted task in return to a respective one of the plurality of cost portions estimated for the respective expert sub-contractor.

19. The computer implemented method of claim 18, wherein each of the cost portions is estimated based on an estimated number of hours required for the respective expert sub-contractor to execute the contracted task, the estimated number of required hours is estimated based on the estimated scope of work and/or is computed by at least one ML model configured to estimate the cost of the contracted task based on at least one pricing paradigm learned based on analysis of a plurality of previously contracted and executed tasks.

20. The computer implemented method of claim 18, further comprising adjusting the estimated cost according to at least one of:
a responsiveness of the expert sub-contractors of the subset to execute the contracted task in return for a respective portion of the estimated total cost, the responsiveness is determined based on a number of the expert sub-contractors of the subset who committed to execute the contracted task by paying a commitment fee, and
past responsiveness of at least one of the expert sub-contractors of the subset to execute at least one previous contracted task in return for a certain reward, and
at least one expert attribute of at least one of the expert sub-contractors of the subset.
